(19) United States
(12) Patent Application Publication
(10) Pub. No.: US 2023/0290954 A1
(43) Pub. Date: Sep. 14, 2023

(54) GRAPHENE METAL ORGANIC FRAMEWORK COMPOSITE ELECTRODES FOR LITHIUM-SULFUR BATTERIES

(71) Applicants: The Johns Hopkins University, Baltimore, MD (US); Northwestern University, Evanston, IL (US)

(72) Inventors: Avery E. Baumann, Baltimore, MD (US); Van Sara Thoi, Baltimore, MD (US); Julia R. Downing, Evanston, IL (US); Mark C. Hersam, Evanston, IL (US)

(73) Assignees: The Johns Hopkins University, Baltimore, MD (US); Northwestern University, Evanston, IL (US)

(21) Appl. No.: 18/017,372

(22) PCT Filed: Jul. 22, 2021
(86) PCT No.: PCT/US2021/042829

§ 371 Date: Jan. 20, 2023

Related U.S. Application Data
(60) Provisional application No. 63/055,153, filed on Jul. 22, 2020.

(51) Int. Cl. H01M 4/62; H01M 10/052; H01M 4/38; H01M 4/60

(52) U.S. Cl. CPC H01M 4/625; H01M 4/38; H01M 4/60; H01M 10/052; C01B 32/19

(57) ABSTRACT

A composition for producing electrodes for lithium-sulfur batteries includes particles having a metal-organic framework structure and composition that define voids within the metal-organic framework structure; sulfur loaded into at least some of the voids defined by the metal-organic framework structure of the particles; graphene flakes obtained by polymer enhanced solvent exfoliation; and polymer residue from the polymer enhanced solvent exfoliation. A method of producing a composite electrode for a lithium-sulfur battery according to an embodiment of the current invention includes obtaining a composition according to an embodiment of the current invention and applying the composition to a substrate. An electrode for a lithium-sulfur battery includes a layer having the composition. A lithium-sulfur battery according to an embodiment of the current invention includes the electrode.

### CROSS-REFERENCE TO RELATED APPLICATIONS

The present patent application claims priority benefit to U.S. Provisional Pat. Application No. 63/055,153, filed on Jul. 22, 2020, the entire content of which is incorporated herein by reference. All references cited anywhere in this specification, including the Background and Detailed Description sections, are incorporated by reference as if each had been individually incorporated.

### FEDERAL FUNDING

This invention was made with government support under grant numbers DMR-1720139, CMMI-1727846, and DMR-1945114 awarded by the National Science Foundation. The government has certain rights in the invention.

### BACKGROUND

### 1. Technical Field

The presently claimed embodiments of the current invention relate to lithium-sulfur batteries, and more specifically to lithium-sulfur batteries that have graphene-metal-organic-framework-sulfur composite electrodes, compositions for making the electrodes and methods of production for the cathode materials.

### 2. Discussion of Related Art

Societal demands for lighter, more sustainable, and higher-performing energy storage devices necessitate the development of post-lithium ion battery technologies. A strong candidate has emerged in lithium-sulfur (Li-S) batteries as a result of the high theoretical energy density (2600 Wh kg⁻¹ and 2800 Wh L⁻¹) and low cost of sulfur.¹ However, Li-S batteries face key issues including severe capacity loss due to polysulfide dissolution and low electrode conductivity, which limit performance and prevent widescale adoption of the technology.² In addition, low sulfur conductivity results in poor utilization, which can be partly mitigated by the inclusion of conductive additives to the cathode architecture such as carbonaceous, inorganic, or polymeric materials.³⁻⁸ For efficient electron transfer, these additives must exhibit good interfacial contact with sulfur and the electrolyte to enable efficient battery cycling. The development of conductive materials with suitable morphologies and the ability to sequester sulfur could dramatically improve such interfaces within the electrode and have a significant impact on energy storage capabilities.

We and others have previously demonstrated that metal-organic frameworks (MOFs) are capable of mitigating capacity fade and improving sulfur utilization by retaining sulfur species within the electrode architecture.⁹⁻¹⁴ However, MOFs also have several drawbacks that restrict their use in batteries including their electronically insulating nature and low density. Employing sulfur-loaded MOFs (denoted as “@S”), in which the pore space is interstitially loaded with sulfur, rather than MOFs physically mixed with sulfur (denoted as “+S”), improves volumetric density but limits electrochemical access to sulfur. Therefore, there remains a need for electrodes for lithium-sulfur batteries with optimized architectures and novel conductive additives.

### SUMMARY

A composition for producing electrodes for lithium-sulfur batteries according to an embodiment of the current invention includes particles having a metal-organic framework structure and composition that define voids within the metal-organic framework structure; sulfur loaded into at least some of the voids defined by the metal-organic framework structure of the particles; graphene flakes obtained by polymer enhanced solvent exfoliation; and polymer residue from the polymer enhanced solvent exfoliation. The particles and the flakes are small relative to the electrodes to form a composite electrode bound at least partially by the polymer residue.

A method of producing a composite electrode for a lithium-sulfur battery according to an embodiment of the current invention includes obtaining a composition according to an embodiment of the current invention and applying the composition to a substrate.

An electrode for a lithium-sulfur battery according to an embodiment of the current invention includes a layer having the composition according to an embodiment of the current invention.

A lithium-sulfur battery according to an embodiment of the current invention includes an electrode according to an embodiment of the current invention.

### BRIEF DESCRIPTION OF THE DRAWINGS

Embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 is a schematic illustration of sulfur loading procedure in representative MOF-808 (top) and cartoon representations of different electrode compositions highlighting the volumetric density afforded by the various components (bottom) according to some embodiments of the current invention.

FIG. 2 shows powder XRD patterns for MOF-808, MOF-808@S, MOF-808@S-high, and S species. Characteristic features of MOF-808 remain unchanged upon sulfur loading. Peaks attributed to sulfur are denoted (*) in the MOF-808@S-high sample.

FIG. 3 shows FT-IR spectra of the MOF-808, MOF-808@S, and MOF-808@S-high samples. The characteristic features of MOF-808 remain unchanged upon sulfur loading.

FIGS. 4A and 4B show thermogravimetric analysis of (a) MOF-808@S and (b) LPS-MOF-808@S samples prepared with initial sulfur loadings of 1:1 (solid lines) and 3:2 of S to MOF-808 (dashed lines) by mass, respectively. The obtained S mass percent for the samples prepared are listed in parentheses in the legend. Sulfur loss occurs below 400° C., the MOF decomposition occurs around 600° C.

FIGS. 5A-5H show compositional analysis of MOF-808@S and MOF-808@S/GEC composite material. Volumetric penetration of sulfur into individual MOF particle and large-area MOF-808@S/GEC composite samples is observed qualitatively. (a-d) Single-particle EDS mapping of MOF-808@S crystal, showing uptake of elemental sulfur as well as elemental O, Zr present in MOF-808. Scale bars are 100 nm for (a-d). Panels (e-h) depict large-area mapping of MOF-808@S/GEC cathode material, showing volumetric homogeneity of sulfur uptake and related elements found in MOF808. Scale bars are 1 um for (e-h).

FIGS. 6A-6F show (a) Vial containing GEC powder used to prepare cathode slurries. (b) SEM of spin-coated graphene film prepared using material from (a) after thermal pyrolysis of ethyl cellulose. (c) AFM of individual drop-casted graphene flakes from (a) after thermal pyrolysis of ethyl cellulose; average of square root of flake area is 138.7 nm, with an average maximum flake thickness of 4.02 nm. SEM images of composite samples containing (d) MOF-808@S with 57 % S and dried slurries of (e) MOF-808@S/GEC, (f) MOF-808+S/SP-75. Graphene is observed as rectangular flakes in (e), while Super-P particles are visible as smaller spheres in (f) The scale bar represents 1 µm in (b-c), 250 nm in (d), and 500 nm in (e-f).

FIG. 7 shows thermogravimetric analysis of GEC used to prepare cathode slurries. The obtained graphene weight ratio is ~53 wt %, with the balance of the specimen being attributed to ethyl cellulose. Ethyl cellulose decomposition begins around 280° C. and is complete by 450° C. as described in our previous studies.⁵

FIGS. 8A-8B show population statistics for nanosheet flake size distributions determined from FIGS. 4A-4B in the main text. The average square root of area is 138.7 nm. Average thickness is 4.02 nm.

FIGS. 9A-9F show dried slurries using various formulation recipes including (a) MOF-808@S/GEC, (b) MOF-808@S-high/GEC, (c) MOF-808@S/SP-90, and (d) MOF-808@S/SP-75, and (e) MOF-808+S/SP-75 samples. The image of MOF-808 is also provided for comparison in panel (f). The scale bar represents 500 nm in all images. Graphene flakes are clearly visible in (a) and (b) as rectangular strips. The small Super-P particles are hard to observe in (c) but discernable in (d) and (e). The particles we identify as Super-P are denoted with yellow arrows.

FIGS. 10A-10F show high magnification micrographs of (a) MOF-808@S and (b) MOF-808@S-high samples along with (c) MOF-808@S/GEC, (d) MOF-808@S-high/GEC, (e) MOF-808@S/SP-90, and (f) MOF-808@S/SP-75 slurries. The scale bar in each image represents 250 nm. Graphene flakes are seen as rectangular strips in (c) and (d), while Super-P particles are hard to observe in (e) but more easily found in (f) as small spherical particles (denoted with yellow arrows). Images (c) and (d) highlight the high degree of interfacial contact between the sulfur-loaded MOF particles and the GEC in the slurry composites compared to the Super-P/PVDF slurry composites (e) and (f).

FIGS. 11A-11I show physicochemical analysis of cathode materials via X-ray photoelectron spectroscopy (XPS), highlighting differences in C1s, S2p, and Zr3d features for (a-c) MOF-808@S/GEC, (d-f) MOF-808@S/SP-90, and (g-i) MOF-808+S/SP-75 samples. Characteristic sp2 bonding consistent with graphene is observed for the MOF808@S/GEC C1s spectrum, while only sp3 bonding character is observed for the MOF-808@S/SP-90 and MOF-808+S/SP-75. Evidence of constituent CH2-CF2 bonds in the PVDF molecular structure and π-π^{∗}delocalization is present in the “SP” C1s spectra. The S2p and Zr3d spectra confirm chemical environments are similar in the MOF-808@S and MOF-808+S samples but differ when mixed with either GEC or Super-P/PVDF to make the slurry composite.

FIG. 12 shows Raman spectra showing D peak (~1350 cm⁻¹) and G peak (~1580 cm⁻ ¹) characteristic of graphene in slurry materials, corresponding to defective structure and graphitic sp² hybridization, respectively.

FIGS. 13A-13B show representative cycling performance of composite electrodes at a cycling rate of C/2 (840 mAh g⁻¹). LPS-MOF-808@S/GEC cells are better able to utilize sulfur resulting in higher deliverable capacities than the MOF-808@S/GEC cells. The MOF-808@S/SP-90 cells at the same loading of active material are not able to deliver substantial capacities. Error bars represent one standard deviation.

FIGS. 14A-14B show results in triplicate for all sulfur-loaded MOF cells discussed in this study. FIG. 14C shows a comparison of results using the middle performing cell for all cathodes. FIG. 14D shows compiled results for all cells, where the average specific capacity at the first cycle (solid) and 100^{th} cycle (striped) are provided. Error bars represent one standard deviation.

FIGS. 15A-15G show cross-section profiles of carbon paper electrodes coated with (a) MOF-808+S/SP-75, (b) MOF-808@S/GEC, and (c) LPS-MOF-808@S/GEC slurries (scale bar is 20 µm). Comparisons of (d) gravimetric and (e) volumetric capacity based on the slurry highlight the denser form factor of the MOF-808@S/GEC compared to MOF-808+S/SP-75 composite electrodes. Rate capability performances from C/2 to 4C expressed (f) gravimetrically based on slurry mass, and (g) volumetrically based on the slurry thickness. The sulfur-loaded MOF cells suffer at rates above 2C due to mass transport limitations.

FIGS. 16A-16D show representative cross-sectional SEM images for carbon paper cathodes coated with (a) MOF-808+S/SP-75, (b) MOF-808@S/GEC, (c) MOF-808@S-high/GEC, and (d) LPS-MOF-808@S/GEC slurries.

FIGS. 17A-17D show rate capabilities for all sulfur-loaded MOF cathode formulations used in this study from C/2 to 4C showing specific capacity (a-b) per gram of sulfur and (c-d) per gram of slurry on the cathode. Cells with high mass % of sulfur in the composite slurry (listed in Table 2) display improved overall gravimetric performance over those with smaller mass % sulfur shown in (c-d). All sulfur-loaded MOF cells exhibit diminished capacity at high C-rates likely owing to the mass transport limitations in the filled MOF pores.

FIGS. 18A-18D show galvanostatic discharge profiles at various C-rates (from C/2 to 4C) demonstrate the differences in sulfur-loaded MOF and physically mixed MOF and sulfur cells. The profiles for (a) MOF-808@S/GEC, (b) LPS-MOF-808@SGEC, (c) MOF-808@S/SP-75, and (d) MOF-808+S/SP-75 are provided. The lack of plateau behavior in sulfur-loaded MOF cells (a-c) at C-rates above 2C indicates there are significant limitations to cycling, presumably mass transport related. This is in contrast to the physically mixed MOF-sulfur composite cell (d) where plateaus are observed even at high C-rates.

FIGS. 19A-19F show cyclic voltammograms (CV) for cells containing (a) MOF-808@S/GEC, (b) LPS-MOF-808@S-low/GEC, (c) MOF-808@S-high/GEC, (d) LPS-MOF-808@S/GEC, (e) MOF-808@S/SP-90, and (f) MOF-808+S/SP-75 cathodes at various scan rates from 0.1 mV s⁻¹ to 0.5 mV s⁻¹. These results were used to calculate the diffusion coefficients in FIGS. 20A-20C and Table 3.

FIGS. 20A-20C show a representative data set of voltammograms is shown in (a) with the d1 and d2 events marked with an arrow connecting peak current (i_{pc}) points. The resulting i_{pc} values are normalized to the mass of sulfur in the electrode and plotted as a function of the square root of scan rate in (b-c). The values of the slopes are provided in the figure and discussed more in Table 3 to follow.

FIGS. 21A-21F show galvanostatic intermittent titration technique (GITT) discharge profiles for cells containing (a) MOF-808@S/GEC, (b) LPS-MOF-808@S/GEC, (c) MOF-808@S/GEC, (d) LPS-MOF-808@S-high/GEC, (e) MOF-808@S/SP-90, and (f) MOF-808+S/SP-75 cathodes. Current was pulsed at a rate of C/10 (168 mA g⁻¹ sulfur) for 10 min and then followed by a rest period of 1 h. The discharge profile obtained using constant current is provided in each figure as the black curve. These results were used to calculate diffusion coefficients in Table 4.

FIGS. 22A-22F show capacity normalized galvanostatic charge-discharge curves (rate of C/2) at (a) cycle 1 and (b) cycle 100 show differences in electrode polarization, denoted at 50 % capacity as ΔV₅₀. The un-normalized curves are also provided in (c). Averaged EIS results for (d) R1 - electrolyte solution resistance, (e) R2 - electrode surface resistance, and (f) R3 - charge transfer resistance values are plotted as a function of the capacity after 100 cycles at C/2.

FIGS. 23A-23F show representative Nyquist plots from collected EIS data for (a) MOF-808@S/GEC, (b) MOF-808@S-high/GEC, (c) MOF-808@S/SP-90, (d) MOF-808@S/SP-75, and (e) LPS-MOF-808@S/GEC cells after 100x galvanostatic charge/discharge cycles. All cells were examined in the discharged state. The curves were modeled using the equivalent circuit shown in (f). The tailing portion beyond the R3 semicircle were not included in the fit analysis.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed, and other methods developed, without departing from the broad concepts of the present invention. All references cited anywhere in this specification are incorporated by reference as if each had been individually incorporated.

Leading energy storage companies are currently rushing to harness the high capacity and specific energy (theoretically 2600-2800 Wh/kg) of Li-S batteries. However, as previously discussed, Li-S batteries face key issues including severe capacity loss due to 1) polysulfide dissolution and 2) low electrode conductivity, which limit performance and prevent widescale adoption of the technology. In addition, low sulfur conductivity results in 3) poor utilization, which can be partly mitigated by the inclusion of conductive additives to the cathode architecture such as carbonaceous, inorganic, or polymeric materials. For efficient electron transfer, these additives must exhibit good interfacial contact with sulfur and the electrolyte to enable efficient battery cycling. Our graphene-MOF nanocomposite electrode method, according to some embodiments of the current invention, meets needs 1), 2) and 3) by exhibiting the correct morphology for good interfacial contact with MOF active materials, improving energy storage capabilities. Notably, our strategy enables cathodes with lower overall mass of carbon/binder additive while improving volumetric density compared to conventional Super-P/PVDF composites, enabling unusually high loading of sulfur-loaded MOF active materials. The use of scalable techniques in our work make this strategy highly attractive to manufacturing scale-up and commercialization.

Previously reported approaches have attempted to address the above-noted problems by increasing the ratio of conductive carbon nanotubes¹⁵⁻¹⁸, graphene oxide¹⁹⁻²², or polymer^{6,23} additives to the sulfur-loaded MOF composite electrode, thus limiting the utilizable mass of active material. Others have reduced the MOF particle size to maximize interparticle contact, but this strategy can also exacerbate polysulfide leaching in MOFs with poor host-guest interactions with sulfur. ^{9,12,13,24,25}

Accordingly, an embodiment of the current invention is directed to a composition for producing electrodes for lithium-sulfur batteries. The electrodes can be cathodes, for example. The composition includes particles that have a metal-organic framework structure and composition that contain voids within the metal-organic framework structure, sulfur loaded into at least some of the voids defined by the metal-organic framework structure of the particles, graphene flakes obtained by polymer-enhanced solvent exfoliation, and polymer residue from the polymer enhanced solvent exfoliation. The particles and the flakes are small relative to the electrodes, forming a nanocomposite electrode bound at least partially by the polymer residue.

In one embodiment, the polymer residue is ethyl cellulose. However, the general concepts of the current invention are not limited to only ethyl cellulose. Other polymers may be used for polymer-enhanced exfoliation which leave the polymer residue. For example, the polymer residue can include at least one of a cellulosic ether, a celluloid, a cellulose derivative, a cellulosic ester, a polyphenol, an acrylate, or a methacrylate polymer.

In some embodiments, the polymer residue can include at least one of hydroxypropyl methylcellulose (HPMC), hydroxypropyl cellulose (HPC), hydroxyethyl cellulose (HEC), methyl cellulose (MC), carboxymethylcellulose (CMC), cellulose nitrate/nitrocellulose (NC), cellulose nanofibers (CNFs), cellulose nanocrystals (CNCs), cellulose acetate (CAc), cellulose acetate-propionate (CAP), cellulose acetate-butyrate (CAB), a tannin, tannic acid, poly(methyl methacrylate) (PMMA), polyethylene glycol methacrylate (PEGMA), methacrylic acid (MAA), allyl methacrylate (AllMA), butyl acrylate (BA), (dimethylamino) ethyl methacrylate (DMAEMA), sodium taurodeoxycholate, sodium cholate (SC), sodium dodecyl sulfate (SDS), sodium lignosulfonate, calcium lignosulfonate, polyvinyl alcohol (PVA), poly(vinylidene fluoride) (PVDF), poly(acrylic acid) (PAA), or polyvinylpyrrolidone (PVP), for example.

In some embodiments, the graphene flakes and the ethyl cellulose can be in a weight ratio of 15:85 to 60:40, for example - in other words, 15-60 wt.% graphene. Within this range, the narrower range of 45-55 wt.% graphene, i.e., 45:55 to 55:45, can be used to maximize electrical conductivity of the graphene nanosheets while 1) maintaining solubility of the graphene ethyl cellulose solids in a wide range of organic solvents and 2) maintaining consistent ink viscosity. In some embodiments, the graphene flakes and the ethyl cellulose can be in a weight ratio of approximately 1:1.

In some embodiments, the metal-organic framework structure can be MOF-808, for example. MOF-808 is known in the art to be composed of zirconium node clusters connected with 1,3,5-benzenetricarboxylate linkers. In some embodiments, the metal-organic framework structure can be a zirconium-based MOF. In some embodiments, the metal-organic framework structure can be any one of MOF-808, UiO-66, or NU-1000, or any combination thereof.

In some embodiments, other MOFs capable of sulfur infiltration can be used. There are many options known in the art. MOFs that are stable to polysulfides, have high internal surface area (> 400 cm³ g-¹), and do not have large particle sizes (< 500 µm) have been found to be suitable.

In some embodiments, the graphene flakes can have a lateral dimension within the range of 50 nm to 1,000 nm. The lateral dimension of the flakes is the square root of mean flake area as determined by atomic force microscopy. In some embodiments, the graphene flakes can have a lateral dimension within the range of 100 nm to 650 nm. In some embodiments, the graphene flakes have a lateral dimension within the range of 100 nm to 200 nm.

In some embodiments, the liquid-phase-exfoliated graphene can be, on average, 3-4 nm thick (also determined by atomic force microscopy). In some embodiments the graphene flakes are categorized as “few-layer graphene” - up to 10 layers, for example. This approach can be orders of magnitude more scalable than other graphene production techniques, while still producing material that is sufficiently electrically conductive for lithium sulfur batteries and related device applications.

Another embodiment of the current invention is directed to a method of producing a composite electrode for a lithium-sulfur battery that includes obtaining a composition according to an embodiment of the current invention and applying the composition to a substrate. The method can include producing the composition.

Another embodiment of the current invention is directed to an electrode for a lithium-sulfur battery that has a layer of material with the composition according to an embodiment of the current invention.

Another embodiment of the current invention is directed to a lithium-sulfur battery that has an electrode according to an embodiment of the current invention.

### EXAMPLES

The following describes some embodiments of the current invention in more detail. However, the general concepts of the current invention are not limited to these specific embodiments.

Herein, we offer a unique approach, according to an embodiment of the current invention, to improve both electrode conductivity and sulfur utilization by using a graphene ethyl cellulose (GEC) nanocomposite additive.

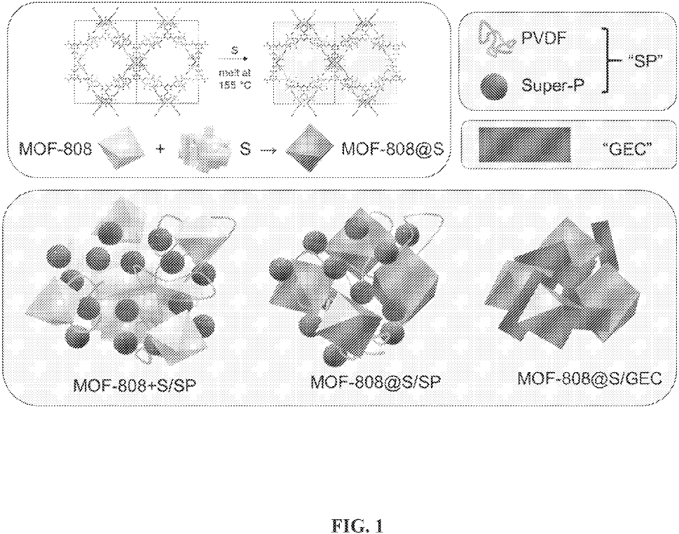

MOF-808 was selected for this study as a representative MOF to demonstrate the efficacy of our composite strategy because it is easily synthesized, highly porous, and features a large number of functionalizable sites on its coordinatively unsaturated Zr metal node.²⁶ The framework itself is electronically insulating and does not have any electrochemical features that compete with Li-S cycling. The morphologies of sulfur-loaded MOFs and graphene nanoflakes afford cathode slurries with more compact volumes than conventional sulfur-mixed MOF formulations (FIG. 1). These sulfur-loaded MOF and graphene nanoflake composites, denoted as “MOF-808@S/GEC”, present a promising opportunity to utilize versatile MOF chemistries in devices without sacrificing volumetric performance.

In conventional Li-S cathode slurry formulations, an additive weight of 20-30 % conductive carbon and polymer binder is needed for sufficient electrical conductivity and slurry adhesion to the current collector, restricting the amount of active material that can be loaded into each electrode.^{2,27,28} Utilizing a higher conductivity carbon material with enhanced interfacial contact has the potential to decrease the mass ratio of carbon to active material. Graphene has historically garnered attention in the field of nanotechnology²⁹ for its high conductivity³⁰, flexibility³¹, and mass-producibility.³² These properties render graphene a strong candidate to replace conventional, amorphous carbon black (Super-P) as a conductive material in battery construction. Meanwhile, ethyl cellulose, a benign polymer additive commonly used in food production, has been identified as an effective stabilizer for top-down graphene synthesis via liquid phase exfoliation.³³ The result of this synthetic approach is a graphene ethyl cellulose nanocomposite powder that can be readily re-dispersed in a variety of solvents, enabling functional inks and coatings.

In previous work, we have demonstrated favorable performance of GEC nanocomposites in cobalt-free lithium ion battery cathodes.^{34,35} In this case, the graphene nanosheets improve charge transport due to their increased conductivity compared to incumbent conductive additives, while ethyl cellulose promotes conformal interfaces between graphene and cathode particles, leading to high volumetric capacity. These results motivated the exploration of GEC in a Li-S battery system, particularly utilizing MOFs as a unique host material for sulfur. Additionally, process innovations were implemented in the graphene synthesis for this work to facilitate scalable production of GEC material with high graphene loading, making this approach broadly applicable to future studies.

### Results/discussion

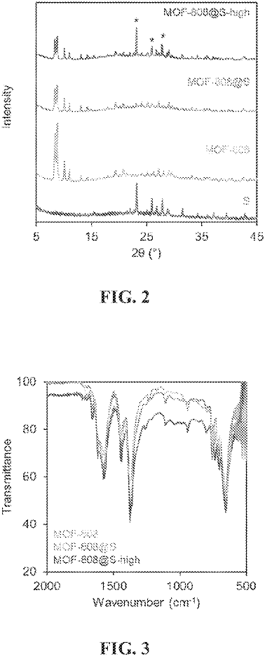

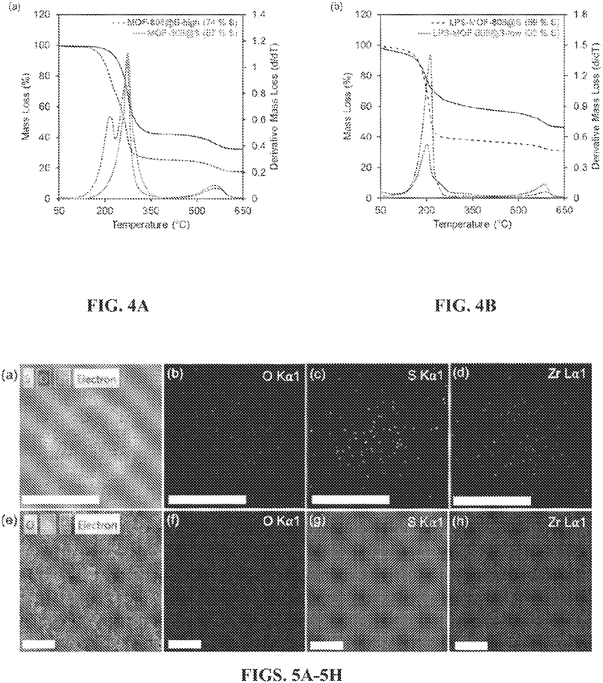

MOF-808 samples were prepared solvothermally (described in the Supplemental Information), activated to remove residual solvent, and subsequently loaded with sulfur by a melt diffusion process at 155° C. to form MOF-808@S (FIG. 1). Sulfur content in the prepared MOF-808@S samples was determined using thermogravimetric analysis (TGA), wherein sulfur is eliminated at temperatures < 350° C. In samples with initial mass loading ratios of 1:1 or 3:2 S:MOF by mass, we achieve sulfur loadings of 57% and 74%, respectively. While the characteristic features of the MOF remain unchanged (FIGS. 2-3), it is worth noting that we also observe evidence of unloaded sulfur in both the TGA and X-ray diffraction pattern in the sample with 74% sulfur loading (“MOF-808@S-high”, FIGS. 2, 4A, 4B), likely due to excess sulfur on the external MOF surface. Qualitative energy-dispersive spectroscopy (EDS) was used to evaluate sulfur uptake into individual MOF crystals (FIGS. 5A-5H). Uniform distribution of oxygen Kα1 and zirconium Lα1 signal is observed, complying with the expected chemical composition of MOF-808. Additionally, concentrated sulfur penetration in the particle is detected and demonstrates successful volumetric uptake of sulfur in the MOF-808@S particles. These characterization results are in agreement with other reports of sulfur-loaded MOFs. ¹⁴⁻²³

Previously, we explored a functionalized MOF-808 with node-bound lithium thiophosphate (“LPS”) guest molecules. ¹⁰ The thiophosphate moiety improves sulfur utilization and Li-S cyclability through the reversible formation of S-S bonds.³⁶ We expect that loading sulfur within the LPS-MOF-808, rather than just physically mixing LPS-MOF-808 and S, enables greater chemical interaction between the thiophosphate and sulfur species inside the porous framework. Sulfur-loaded LPS-MOF-808 samples were prepared and characterized in an analogous manner as the aforementioned MOF-808@S samples, resulting in samples with 32% and 59% incorporated sulfur species by mass for loading ratios of 1:1 and 3:2 S:MOF, respectively (FIGS. 4A-4B). We attribute the differences in sulfur loading from the MOF-808@S and LPS-MOF-808@S to the incorporated LPS guest molecule, which takes up pore space that could otherwise be occupied by sulfur. The sample with only 32% sulfur will be referred to as “LPS-MOF-808@S-low.” For further discussion, the MOF-808@S (57% S) and LPS-MOF-808@S (59% S) samples will be directly compared due to their nearly identical mass percent of encapsulated sulfur.

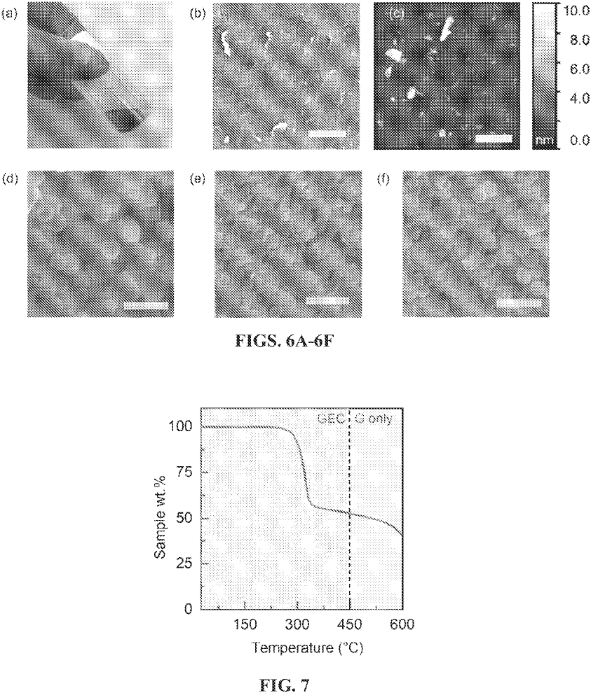

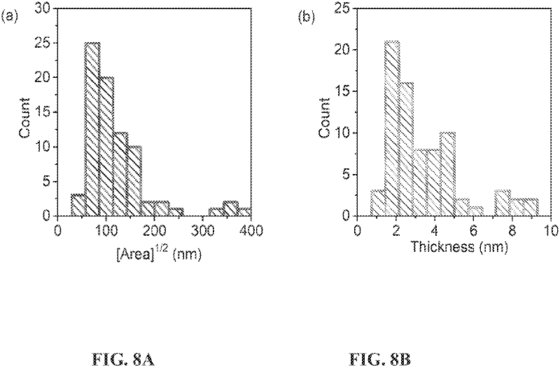

As previously mentioned, the synthesis of the GEC nanocomposite has been reported for other applications, namely printed electronics³⁷ and lithium ion batteries. ^{34,35} However, further optimization of the shear mixing parameters enables us to maximize the relative weight fraction of graphene to ethyl cellulose in the GEC powder to ~1:1, which is essential to minimize the overall slurry mass while maintaining a high amount of conductive material in the GEC nanocomposite. Briefly, top-down exfoliation of bulk graphite was implemented via inline shear mixing with ethyl cellulose in a pilot-scale manufacturing process. After purifying shear-mixed GEC dispersions by centrifugal post-processing, graphene nanosheets of controlled size and thickness were stabilized with ethyl cellulose in a dry powder (FIG. 6A). Scanning electron microscopy (SEM) and atomic force microscopy (AFM) indicate successful synthesis of large, thin few-layer graphene flakes after pyrolytic decomposition of ethyl cellulose (FIGS. 6B-6C). Thermogravimetric analysis of the GEC sample is shown in FIG. 7; this work was carried out using a GEC powder that was 53% graphene and 47% ethyl cellulose by weight (~1:1 graphene to ethyl cellulose ratio). The high surface area of these graphene nanosheets lends itself to high-quality flake-to-flake contacts in a percolating film (FIG. 6B). Detailed flake size distributions from AFM (FIG. 6C) are also provided in FIGS. 8A-8C.

Following synthesis and characterization of the various component materials, MOF composite slurries were prepared using GEC as the only additive contributing to the electronic conductivity (via graphene, as a source of carbon) and cathode stability (via ethyl cellulose, eliminating the need for an additional polymer binder). The superior electronic conductivity of the graphene nanoflakes (250 S cm⁻¹)³¹ compared to Super-P (5-30 S cm⁻¹),³⁸ a conventionally used carbon black additive, allows lower weight fractions of the graphene additive (10% by mass) compared to Super-P composites (typically 15% by mass) for efficient electron delivery to the sulfur species. ^{10,39} In addition, the expected enhanced interfacial contact between GEC and sulfur-loaded MOF enables the omission of PVDF, a common polymeric binder used in electrode fabrication that takes up an additional 10% of the slurry mass.^{27,40}

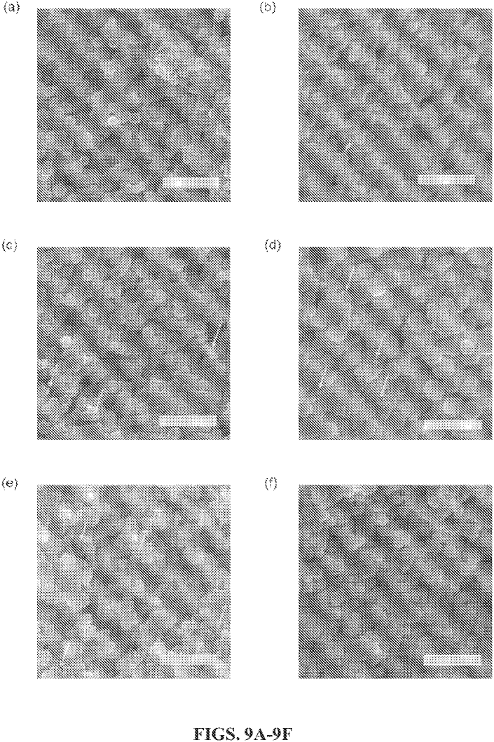

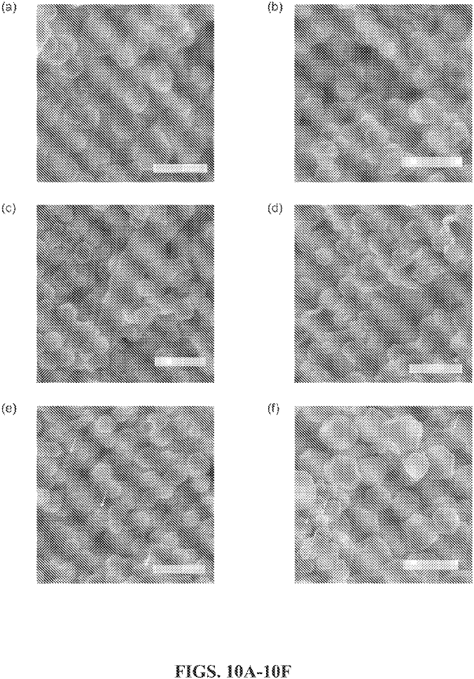

SEM images of dried slurries clearly show the MOF-808@S particles and the graphene flakes are in intimate contact and well distributed throughout the mixture (FIG. 6E). In contrast, images of dried slurries composed of Super-P/PVDF (“MOF-808@S/SP-90”) at the same mass loading exhibit tentatively discernable carbon particles (~40 nm spheres)³⁸ intermittently in contact with the sulfur-loaded MOF particles (FIGS. 9A-9F, 10A-10F). Only when the Super-P/PVDF content is increased to 25% by mass (“MOF-808@S/SP-75”) are the small Super-P particles visibly in contact with MOF-808@S throughout the slurry (FIGS. 6F, 9A-9F, 10A-10F). EDS analysis of the MOF-808@S/GEC composite slurries (FIGS. 5A-5H) also show strong sulfur Kα1 penetration throughout the sample in addition to a consistent distribution of oxygen and zirconium. In future studies, liquid in-situ TEM may be particularly useful to even better visualize how sulfur undergoes conversion within the MOF during cycling.⁴¹

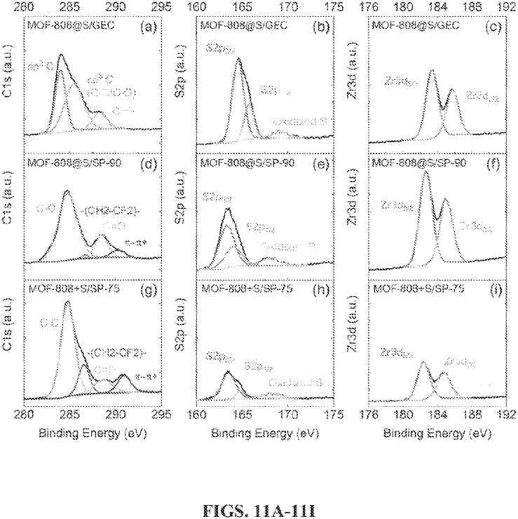

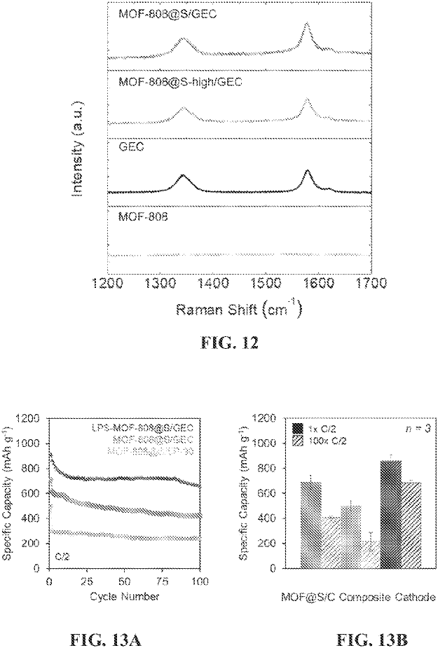

We employed X-ray photoelectron spectroscopy (XPS) to examine the binding energies of constituent chemical species of the prepared electrode slurries. Spectra for C1s, S2p, and Zr3d regions were collected for each sample to gather information about the GEC, sulfur, and MOF components of the slurry (FIGS. 11A-11I). For this study, three samples were investigated: MOF-808@S/GEC (FIGS. 11A-11C), MOF-808-@S/SP-90 (FIGS. 11D-11F), and MOF-808+S/SP (FIGS. 11G-11I). In the C1s spectra of MOF-808@S/GEC (FIG. 11A), constituent sp² and sp³ peaks characteristic of graphene and ethyl cellulose are identified at ~284 and ~285 eV, respectively, which are qualitatively consistent with our previous report.⁴² This C1s spectra is also in agreement with previously identified features of MOF-808, where the carboxylate feature of the organic linker is also observed.^{43,44} The position of the orange peak associated with sp³ bonding in the GEC sample has a different position than the orange C-C peaks in the C1s spectra of the slurries prepared with Super-P/PVDF (FIGS. 11D, 11G) due to the contribution of C-O bonds in the ethyl cellulose molecular structure in the GEC sample. There are other key differences in the C1s spectra for the Super-P/PVDF samples; in particular, no sp² peak is observed, which is expected for amorphous carbon, while a small peak emerges at ~286 eV corresponding to -(CH₂-CF₂)- monomers in the molecular structure of PVDF.⁴⁵ Additionally, π-π^{∗} delocalization characteristic of CF₂ in (-CH₂-CF₂-)ₙ is distinguishable at ~291 eV.⁴⁶ Further analysis via Raman spectroscopy (FIG. 12) confirms the presence of graphene in the MOF-808@S/GEC specimens.

In the S2p spectra for all samples, we observe spin-orbit splitting that yields distinct S2p_{½} and S2p_{3/2} peaks with the binding energy of the S2p_{½} peaks in the range 163-165 eV and the corresponding S2p_{3/2} peaks in the range 164-166 eV, which is indicative of an S⁰ oxidation state (FIGS. 11B, 11E, 11H). Additionally, a small feature at 168-170 eV is observed in all samples that we attribute to oxidized sulfur. While the S2p spectra are similar for the three samples, they are not identical. A noticeable peak shift is observed for the S2p_{3/2} fitted peaks between the GEC and Super-P/PVDF-containing samples where the S2p_{3/2} peak falls at ~163.5 eV for the MOF-808@S/SP-90 (FIG. 1E) and the MOF-808+S/SP-75 (FIG. 11H) samples, but is shifted by almost 1 eV to 164.5 eV for the MOF-808@S/GEC sample (FIG. 11B). Since the peak positions are consistent for MOF-808@S/SP-90 and MOF-808+S/SP-75, we attribute the observed difference in the MOF-808@S/GEC to the choice of cathode additive (SP or GEC) and not the sulfur loading procedure.

In all of the Zr3d spectra, the Zr3d_{5/2} and Zr3d_{3/2} peaks are discerned at 182-184 eV and 184-186 eV, respectively (FIGS. 11C, 11F, 11I) and are in general agreement with previously reported values for MOF-808.^{22,44,47} However, it should again be noted that there is non-trivial peak shift between the different samples where the binding energy of the Zr3d_{5/2} peak is ~182.5 eV for the Super-P/PVDF-containing samples (FIGS. 11F, 11I) but nearly 1 eV higher (183.4 eV) for the GEC sample (FIG. 11C). Consistent with our discussion above, we conclude that the choice of mixing or volumetrically loading sulfur into the MOF has a negligible effect on the positions of the Zr3d features, while the choice of carbon source in the slurry (GEC or SP) has a more profound effect. We postulate that the improved interfacial contact between MOF-808@S particles and GEC lead to electrostatic charge shifts, resulting in the positive shifts in the S and Zr electron binding energies and the negative shift in C1s sp³ and sp² binding energies from reported GEC spectra (~ 1 eV lower).⁴² Further studies using density functional theory (DFT) calculations would be helpful to pinpoint the mechanisms behind these electrostatic charge shifts, drawing upon prior DFT-enabled insights regarding adsorption mechanisms between graphene, sulfur and long-chain polysulfides.⁴⁸

Armed with physicochemical analysis of our materials indicating successful sulfur uptake within the MOF host and good contact between GEC and sulfur-loaded MOF, we proceeded with electrochemical characterization. Electrodes were prepared by casting the various slurries onto carbon paper supports, as described in the Supplemental Information. Galvanostatic cycling experiments were conducted using a charge/discharge rate (“C-rate” where 1C = 1680 mA g⁻¹) of C/2 to evaluate the performance of the different materials and slurry formulations. For cycling discussion, unless otherwise stated, the slurry composition is fixed to 90% MOF-808@S and 10% carbon/binder additives. Additionally, all cathode formulations used in this study are provided in Table 1.

TABLE 1

The composition of each slurry used in this study is provided in the table

| Sample Name | Slurry MOF wt % | Swt% | C + Binder wt % |
|---|---|---|---|
| LPS-MOF-808@S/GEC | 37% | 53% | 10% GEC |
| LPS-MOF-808@S-low/GEC | 61% | 29% | 10% GEC |
| MOF-808@S/GEC | 39% | 51% | 10% GEC |
| MOF-808@S-high/GEC | 23% | 67% | 10% GEC |
| MOF-808@S/SP-75 | 32% | 43% | 15% Super-P 10% PVDF |
| MOF-808@S/SP-80 | 39% | 51% | 6% Super-P 4% PVDF |
| MOF-808+3/3P - 75 | 30% | 45% | 15% Super-P 10% PVDF |

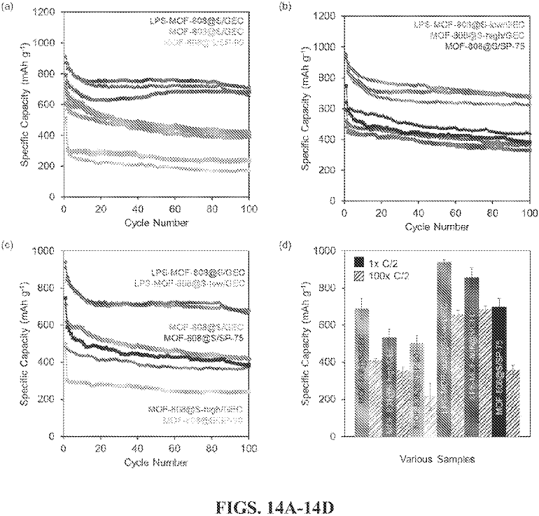

The cells prepared with MOF-808@S/GEC cathodes deliver an average capacity of 688 ± 56 mAh g⁻¹ for their first cycle and 409 ± 10 mAh g⁻¹ after completing 100 cycles, a significant improvement over cells containing MOF-808@S/SP-90 which delivered an average of 500 ± 7 mAh g⁻¹ and 214 ± 30 mAh g⁻¹ at the first and 100^{th} cycle respectively (FIGS. 13A-13B). Only when the SP content is increased to 25% by mass (MOF-808@S/SP-75) are the galvanostatic cycling results comparable to the MOF-808@S/GEC data (FIGS. 14A-14D), suggesting that the quality of the electronic contact between the carbon and MOF particles is critical. These drastic performance differences highlight the superior ability of GEC to enhance cyclability at low mass loading compared to SP. Furthermore, cathodes constructed with GEC exhibit improved capacity retention compared to those containing Super-P/PVDF - 59.4% vs. 51.2%, respectively - indicating that GEC can slightly better mitigate migration of polysulfide species (FIGS. 14A-14D).

Functionalization of MOF-808 showed further enhancements in cycling performance. The LPS-MOF-808@S/GEC cells outperformed their unfunctionalized counterparts with initial and final capacities of 858 ± 51 mAh g⁻¹ and 685 ± 18 mAh g⁻¹, respectively, a capacity retention of 79.8% (FIGS. 13A-13B, triplicate data shown in FIGS. 14A-14D). The cycling results for LPS-MOF-808@S/GEC cells demonstrate both sulfur utilization and capacity retention are improved compared to the MOF-808@S/GEC cells. We attribute these differences in performance to chemical interaction of the thiophosphate moiety with both sulfur and polysulfides in the cell. Furthermore, the LPS-MOF-808@S/GEC cells deliver capacities that are just slightly diminished from the values of LPS-MOF-808+S/SP-75 (prepared using 75% LPS-MOF-808+S and 25% Super P + PVDF by mass) achieved in our previous report (~1070 mAh g⁻¹) in the first cycle at C/2.¹⁰

Comparing the MOF-808@S/GEC and MOF-808+S/SP-75 cycling results with and without LPS functionalization, the thiophosphate moiety enhances capacity delivery by 24.7% (~170 mAh g⁻¹ out of 688 mAh g⁻¹) in the MOF-808@S cells, whereas the MOF-808+S cells only increase by 11.5% (~110 mAh g⁻¹ out of 960 mAh g⁻¹). This capacity enhancement from LPS incorporation is even more drastic in cells prepared with the LPS-MOF-808@S-low/GEC sample (with only 32% by mass sulfur), which yields an average capacity of 940 ± 12 mAh g⁻¹, an increase in capacity of 36.6% (FIGS. 14A-14D). The capacity enhancement suggests that the LPS functional group has a greater impact on sulfur utilization in the sulfur-loaded MOF compared to MOF physically mixed with sulfur.

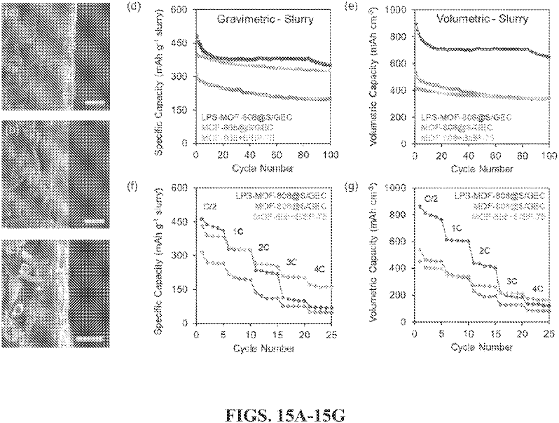

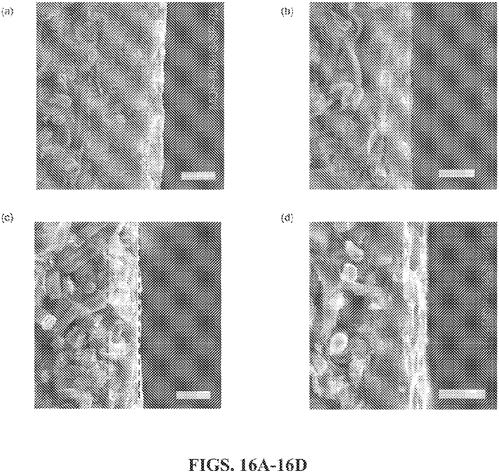

We next investigate how the morphologies of the slurry components influence the volumetric performance of these cells. SEM images of MOF-808@S/GEC and LPS-MOF-808@S/GEC cathodes (FIGS. 15A-15C, 16A-16D) display more dense slurry coatings compared to MOF-808+S/SP-75 cathodes, with average volumetric loadings calculated in Table 2. From these measurements, it is evident the sulfur-loaded MOF samples exhibit superior packing efficiency on the cathode surface, important for maximizing volumetric output of the cell. We demonstrate this effect in FIGS. 15D-15E where MOF-808@S/GEC delivers much less capacity per gram of slurry than the conventional MOF-808+S/SP-75 cathode but exhibits comparable performance when examined per cubic centimeter of slurry coating. Similarly, comparing LPS-MOF-808@S/GEC and MOF-808+S/SP-75 cell performances in FIG. 15E highlights the significant improvement in volumetric capacity delivery to nearly 900 mAh cm⁻³ achievable using our optimized formulation. We note that our results represent a proof-of-concept, as our measurements only account for the slurry thickness and do not include dimensions of the carbon paper current collector. Translation of these slurries to foil current collectors and manipulation of the areal sulfur loading extent would further improve the total volumetric output of the electrode.

TABLE 2

The slurry thickness was measured using ImageJ processing freeware at a minimum of 50 locations. Values for one standard deviation of all measurements are included in the table

| | MOG 808+S/SP -75 | MOF-808@S/GEC | MOF-808@S-high/GEC | LP5-MOF⁻808@S/GEC |
|---|---|---|---|---|
| Cathode S mass (mg) | 2.028 | 2.460 | 2.426 | 1.8077 |
| Cathode area (cm²) | 1.267 | 1.267 | 1.267 | 1.267 |
| Slurry Thickness (µm) [# of measurements] | 34.0 ± 6.2 [n = 54) | 22.3 ± 5.7 [n = 86] | 22.4 ± 8.6 [n = 78] | 14.5 ± 3.7 [n = 124] |
| Slurry Density (g cm³) | 0.47 ± 0.07 | 0.87 ± 0.18 | 0.85 ± 0.24 | 0.98 ± 0.20 |

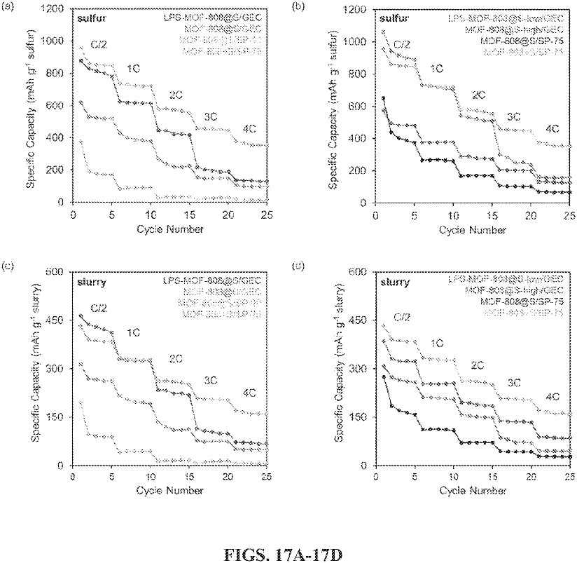

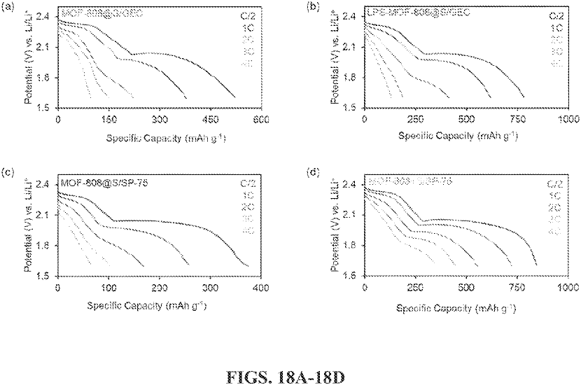

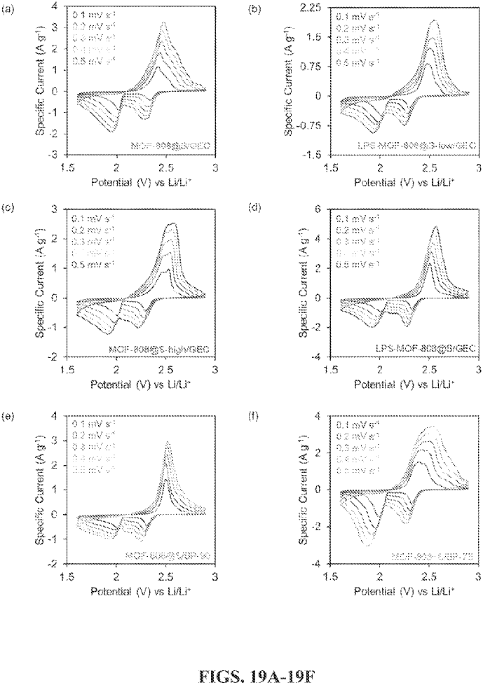

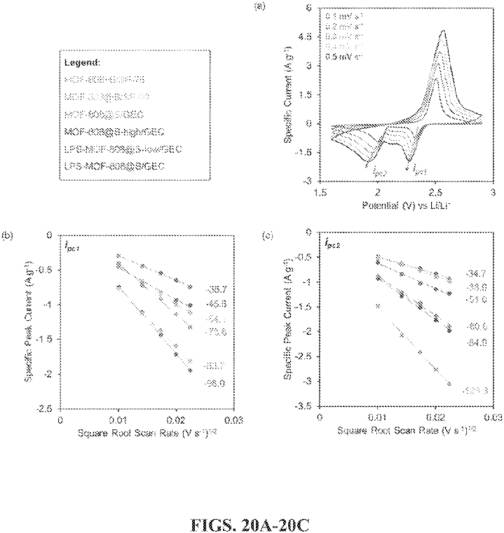

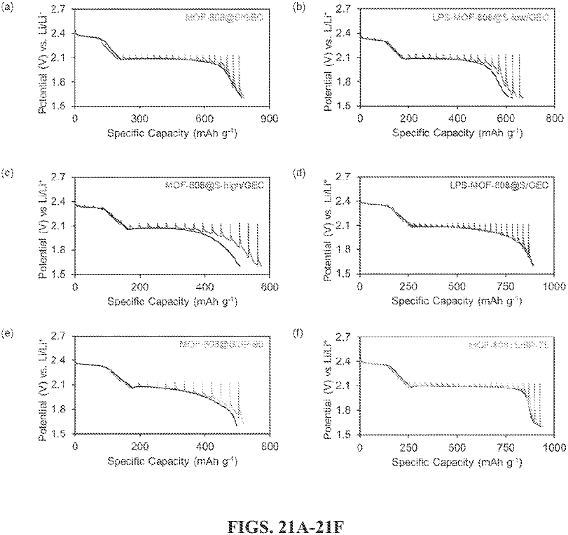

Additional electrochemical experiments provide insight into the limitations of the sulfur-loaded MOF cells. In rate capability experiments, increasing C-rate decreases capacity delivered with each incremental step (FIGS. 15F-15G). LPS-MOF-808@S/GEC cells perform well at moderate C-rates, but capacities are markedly decreased as the rate is increased above 2C. This drop in performance at high charge rate is also seen for all of the other cells containing sulfur-loaded MOF (FIGS. 17A-17D). We attribute this effect to inhibited diffusion inside the sulfur-loaded MOFs, which limits mass transport and thus the ability to cycle effectively at higher rates. In the MOF-808+S/SP-75 composite, sulfur exists outside the MOF and is less dependent on mass transport within the cathode at high C-rates than the sulfur-loaded MOF cells (regardless of slurry composition), enabling effective cycling. This hypothesis is confirmed by the non-plateau behavior in the discharge curves of sulfur-loaded MOF compared to sulfur-mixed MOF cells in FIGS. 18A-18D.⁴⁹⁻⁵¹ We further evaluated electrochemically controlled diffusion processes using cyclic voltammetry (FIGS. 19A-19F, 20A-20C, Table 3) and galvanostatic intermittent titration technique (GITT) experiments (FIGS. 21A-21F, Table 4). Both scan rate dependence cyclic voltammograms and GITT discharge profiles generally show the MOF-808@S/GEC and LPS-MOF-808@S/GEC cells exhibit slower diffusion than the MOF-808+S/SP-75 cell, although significant variations in electrode architecture may also contribute to these results, as discussed more thoroughly in Tables 3-4.

TABLE 3

Compiled results and analysis methods for CV experiments. Results are also shown in FIGS. 20A-20C above

| Cathode Composition | d1 slope (i_{pc1}) (A g⁻¹)(V s⁻¹)^{-½} | d2 slope (i_{pc2}) (A g⁻¹)(V s⁻¹)^{-½} |
|---|---|---|
| MOF-808@S/GEC | -73.6 | -80.6 |
| MOF-806@S-high/GEC | -45.6 | -51.0 |
| LPS-MOF-808@S-low/GEC | -35.7 | -34.7 |
| LPS-MOF·-808@S/GEC | -98.0 | -84.9 |
| MOF-808@S/SP-90 | -54.1 | -38.9 |
| MOF-809@S/SP-75 | -83.7 | -126.3 |

TABLE 4

Calculated diffusion coefficients at select depth of discharge (40% and 80%) using GITT profiles as outlined in a previous report ¹⁰

| | | |
|---|---|---|
| Cathode Composition | D (cm² S⁻¹) Point 1 (~40 % discharged) | D (cm² s⁻¹) Point 2 (~80 % discharged) |
| MOF-808@S/GEC | 1.3E-05 | 4.0E-05 |
| MOF-808@S-high/GEC | 1.2E-05 | 3.7E-05 |
| LPS-MOF-808@S-low/GEC | 1.5E-05 | 2.7E-05 |
| LPS-MOF-808@S/GEC | 1.3E-05 | 2.8E-05 |
| MOF-808@S/SP-90 | 6.1E-06 | 2.2E-05 |
| MOF-808+S/SP-75 | 4.3E-05 | 2.9E-05 |

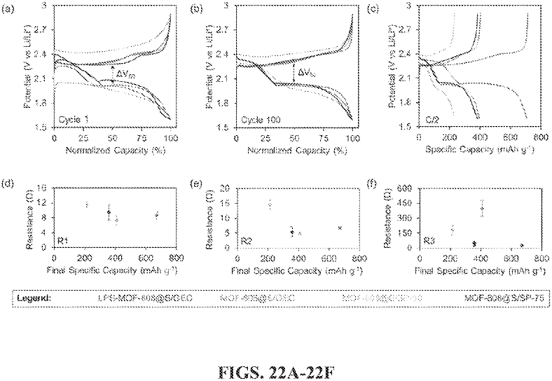

The differences in cycling performance prompted us to explore further electrochemical differences among these electrodes. Normalized galvanostatic capacity-voltage curves shown in FIGS. 22A-22B overlap for MOF-808@S/GEC and LPS-MOF-808@S/GEC curves, suggesting their cycling mechanisms and redox equilibration potentials are similar; however, differences arise in the analogous MOF-808@S/SP-90 cell. In particular, significant polarization at 50 % state of discharge (denoted ΔV₅₀) occurs in the MOF-808@S/SP-90 cells in both the first and final cycle at C/2 (FIGS. 22A-22F), indicative of impeded Li⁺/e⁻ transport needed for cycling. ^{52,53} Only when the Super-P/PVDF content is returned to 25 % by mass in the slurry formulation are the voltage differences consistent with the GEC cells. This observed electrode polarization results in diminished energy output of the cell and highlights the deficits of the MOF-808@S/SP-90 cathodes.

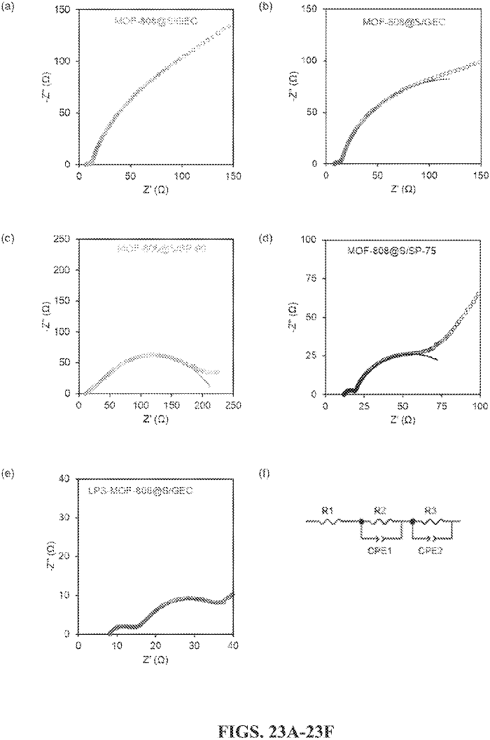

Further analysis using electrochemical impedance spectroscopy (EIS) measurements collected from cells after cycling provides insight into electrochemical differences resulting from different slurry compositions (FIGS. 22E-22F). The equivalent circuit used to model impedance data is included with representative Nyquist plots in FIGS. 23A-23F. R1 is attributed to the electrolyte solution resistance, affected by the dissolution of ionic species that increase the electrolyte viscosity, predominantly lithium polysulfides. All of the values for sulfur-loaded MOF cells tested are similar to those reported elsewhere. ^{10,16} Additionally, it is worth noting that GEC-containing cells exhibit lower R1 values than Super-P/PVDF cells (FIG. 22D), supporting the claim that the GEC additive plays a role in the suppression of polysulfide leaching.

R2 is identified as the electrode surface resistance, caused by both deposited sulfur species and electronically isolated islands of active material. The MOF-808@S/SP-90 cells exhibit three times higher R2 compared to the MOF-808@S/GEC cells, implying that surface resistance is likely the key contributor to the observed electrode polarization as discussed above. In accordance with our previous discussion, the surface resistance drops when the Super-P/PVDF content is increased to 25 % of the slurry mass for MOF-808@S/SP-75.

A similar result is obtained for R3, assigned to charge transfer resistance, in that the MOF-808@S/SP-75 cells have lower resistance than the MOF-808@S/SP-90 cells after cycling. The R3 values are unexpectedly higher for the MOF-808@S/GEC cells compared to MOF-808@S/SP-90 cells despite a smaller electrode polarization. However, introduction of the thiophosphate moiety in LPS-MOF-808@S/GEC lowers the R3 value, suggesting the charge transfer resistance could be linked to the accessibility of sulfur. This argument is supported by the increased length of the galvanostatic charge/discharge curves (FIG. 22C) where the LPS-MOF-808@S/GEC cells utilize more sulfur throughout the discharge process. These results strongly suggest that the thiophosphate improves cyclability by lowering charge transfer resistance, enabling more efficient equilibration along both the upper and lower galvanostatic discharge plateaus.

### Conclusion

In summary, our graphene nanoflake strategy improves the utility of sulfur-loaded MOF samples for Li-S batteries by improving both the conductivity and interfacial contact in the cathode slurry. The electronic and morphological properties of the GEC additive enable slurry formulations that employ a lower mass of carbon/binder additive, while also significantly improving the volumetric density of the cathode compared to conventional Super-P/PVDF composites. Extensive physicochemical characterization has been performed on the MOF/GEC nanocomposite electrodes to identify constituent species and investigate interactions between the MOF, sulfur, and carbon/binder components. We further demonstrate that loading sulfur into functionalized MOFs enhances the effect of the functional group, here lithium thiophosphate (LPS), resulting in Li-S cells that are able to better access constituent sulfur and deliver higher capacities than the parent MOF/GEC nanocomposite cells. While this work affords additional opportunities for functionalized MOFs in electronic device applications, there is still more to be understood with regards to mass transport limitations in sulfur-loaded versus sulfur-mixed MOF cells. Conformal GEC coatings may also be provided on the MOF particles to enhance electrical conductivity of the cathode and permit scalable processing.

### REFERENCES

(1) He, J.; Manthiram, A. A Review on the Status and Challenges of Electrocatalysts in Lithium-Sulfur Batteries. Energy Storage Mater. 2019, 20, 55-70. https://dpo.org/10.1016/j.ensm.2019.04.038.

(2) Chung, S. H.; Chang, C. H.; Manthiram, A. Progress on the Critical Parameters for Lithium-Sulfur Batteries to Be Practically Viable. Adv. Funct. Mater. 2018, 28, 1801188. https://doi.ore/10.1002/adfm.201801188.

(3) Dong, C.; Gao, W.; Jin, B.; Jiang, Q. Advances in Cathode Materials for High-Performance Lithium-Sulfur Batteries. iScience 2018, 6, 151-198. https://doi.org/10.1016/j.isci.2018.07.021.

(4) Tang, H.; Li, W.; Pan, L.; Tu, K.; Du, F.; Qiu, T.; Yang, J.; Cullen, C. P.; McEvoy, N.; Zhang, C. (John). A Robust, Freestanding MXene-Sulfur Conductive Paper for Long-Lifetime Li-S Batteries. Adv. Funct. Mater. 2019, 29, 1901907. https://doi.org/10.1002/adfm.201901907.

(5) Xiao, Z.; Li, Z.; Meng, X.; Wang, R. MXene-Engineered Lithium-Sulfur Batteries. J. Mater. Chem. A 2019, 7 (40), 22730-22743. https://doi.org/10.1039/c9ta08600e.

(6) Jiang, H.; Liu, X. C.; Wu, Y.; Shu, Y.; Gong, X.; Ke, F. S.; Deng, H. Metal-Organic Frameworks for High Charge-Discharge Rates in Lithium-Sulfur Batteries. Angew. Chemie - Int. Ed. 2018, 57 (15), 3916-3921. https://doi.org/10.1002/anie.201712872

(7) Jin, L.; Huang, X.; Zeng, G.; Wu, H.; Morbidelli, M. Conductive Framework of Inverse Opal Structure for Sulfur Cathode in Lithium-Sulfur Batteries. Sci. Rep. 2016, 6, 32800. https://doi.org/10.1038/srep32800.

(8) Zeng, S.; Li, L.; Xie, L.; Zhao, D.; Wang, N.; Chen, S. Conducting Polymers Crosslinked with Sulfur as Cathode Materials for High-Rate, Ultralong-Life Lithium-Sulfur Batteries. ChemSusChem 2017, 10 (17), 3378-3386. https://doi.org/10.1002/cssc.201700913.

(9) Baumann, A. E.; Aversa, G. E.; Roy, A.; Falk, M. L.; Bedford, N. M.; Thoi, V. S. Promoting Sulfur Adsorption with Surface Cu Sites in Metal-Organic Frameworks for Lithium Sulfur Batteries. J. Mater. Chem. A 2018, 6, 4811-4821. https://doi.org/10.1039/C8TA01057A.

(10) Baumann, A. E.; Han, X.; Butala, M. M.; Thoi, V. S. Lithium Thiophosphate Functionalized Zirconium MOFs for Li-S Batteries with Enhanced Rate Capabilities. J. Am. Chem. Soc. 2019, 141 (44), 17891-17899. https://dot.org/10.1021/jacs.9b09538.

(11) Zheng, J.; Tian, J.; Wu, D.; Gu, M.; Xu, W.; Wang, C.; Gao, F.; Engelhard, M. H.; Zhang, J.-G. G.; Liu, J.; Xiao, J. Lewis Acid-Base Interactions between Polysulfides and Metal Organic Framework in Lithium Sulfur Batteries. Nano Lett. 2014, 14 (5), 2345-2352. https://doi.org/10.1021/n1404721h.

(12) Hong, X. J.; Tan, T. X.; Guo, Y. K.; Tang, X. Y.; Wang, J. Y.; Qin, W.; Cai, Y. P. Confinement of Polysulfides within Bi-Functional Metal-Organic Frameworks for High Performance Lithium-Sulfur Batteries. Nanoscale 2018, 10 (6), 2774-2780. https://doi.org/10.1039/c7nr07118c.

(13) Bai, L.; Chao, D.; Xing, P.; Tou, L.; Chen, Z.; Jana, A.; Shen, Z.; Zhao, Y. Refined Sulfur Nanoparticles Immobilized in Metal-Organic Polyhedron as Stable Cathodes for Li-S Battery. ACS Appl Mater Interfaces 2016, 8, 14328-14333. https://doi.org/10.1021/acsami.6b04697.

(14) Park, J. H.; Choi, K. M.; Lee, D. K.; Moon, B. C.; Shin, S. R.; Song, M.-K.; Kang, J. K. Encapsulation of Redox Polysulphides via Chemical Interaction with Nitrogen Atoms in the Organic Linkers of Metal-Organic Framework Nanocrystals. Sci. Rep. 2016, 6, 25555. https://doi.org/10.1038/srep25555.

(15) Mao, Y.; Li, G.; Guo, Y.; Li, Z.; Liang, C.; Peng, X.; Lin, Z. Foldable Interpenetrated Metal-Organic Frameworks/Carbon Nanotubes Thin Film for Lithium-Sulfur Batteries. Nat. Commun. 2017, 8, 14628. https://doi.org/10.1038/ncomms14628.

(16) Liu, X.; Wang, S.; Wang, A.; Wang, Z.; Chen, J.; Zeng, Q.; Chen, P.; Liu, W.; Li, Z. xi; Zhang, L. A New Cathode Material Synthesized by Thiol-Modificatory Metal-Organic Framework (MOF) Covalently Connecting Sulfur for Superior Long-Cycling Stability Lithium-Sulfur Batteries. J. Mater. Chem. A 2019, 7 (8), 3971-3978. htpps:doi.org/10.1039/C9TA08043K.

(17) Xu, G.; Zuo, Y.; Huang, B. Metal-Organic Framework-74-Ni/Carbon Nanotube Composite as Sulfur Host for High Performance Lithium-Sulfur Batteries. J. Electroanal. Chem. 2018, 830-831, 43-49. https://doi.org/10.1016/j.jelechem.2018.10.028.

(18) Zhang, H.; Zhao, W.; Zou, M.; Wang, Y.; Chen, Y.; Xu, L.; Wu, H.; Cao, A. 3D, Mutually Embedded MOF@Carbon Nanotube Hybrid Networks for High-Performance Lithium-Sulfur Batteries. Adv. Energy Mater. 2018, 8, 1800013. https:doi.org/10.1002/aenm.201800013.

(19) Wu, Y.; Jiang, H.; Ke, F.; Deng, H. Three-Dimensional Hierarchical Constructs of MOF-on-Reduced Graphene Oxide for Lithium-Sulfur Batteries. Chem. - An Asian J. 2019, 3577-3582. https://doi.org/10.1002 asia.201900848.

(20) Bao, W.; Zhang, Z.; Qua, Y.; Zhou, C.; Wanga, X.; Li, J. Confine Sulfur in Mesoporous Metal-Organic Framework @ Reduced Graphene Oxide for Lithium Sulfur Battery. J. Alloys Compd. 2014, 582, 334-340. https://doi.org/10.1016 /j_{.}jallcom.2013.08.056.

(21) Zhao, Z.; Wang, S.; Liang, R.; Li, Z.; Shi, Z.; Chen, G. Graphene-Wrapped Chromium-MOF(MIL-101)/Sulfur Composite for Performance Improvement of High-Rate Rechargeable Li-S Batteries. J. Mater. Chem. A 2014, 2 (33), 13509-13512. https://doi/org/10.1039/c4ta01241k.

(22) Pu, Y.; Wu, W.; Liu, J.; Liu, T.; Ding, F.; Zhang, J.; Tang, Z. A Defective MOF Architecture Threaded by Interlaced Carbon Nanotubes for High-Cycling Lithium-Sulfur Batteries. RSC Adv. 2018, 8 (33), 18604-18612. https://doi.org/10.1039/c8ra02254b.

(23) Geng, P.; Cao, S.; Guo, X.; Ding, J.; Zhang, S.; Zheng, M.; Pang, H. Polypyrrole Coated Hollow Metal-Organic Framework Composites for Lithium-Sulfur Batteries. J. Mater. Chem. A 2019, 7 (33), 19465-19470. https://doi.org/10.1039/c9ta05812e.

(24) Zhou, J.; Yu, X.; Fan, X.; Wang, X.; Li, H.; Zhang, Y.; Li, W.; Zheng, J.; Wang, B.; Li, X. The Impact of the Particle Size of a Metal-Organic Framework for Sulfur Storage in Li-S Batteries. J. Mater. Chem. A 2015, 3 (16), 8272-8275. https://doi.org/10.1039/C5TA00524H.

(25) Zhou, J.; Li, R.; Fan, X.; Chen, Y.; Han, R.; Li, W.; Zheng, J.; Wang, B.; Li, X. Rational Design of a Metal-Organic Framework Host for Sulfur Storage in Fast, Long-Cycle Li-S Batteries. Energy Environ. Sci. 2014, 7 (8), 2715-2724. https://doi.org/10.1039/C4EE01382D.

(26) Furukawa, H.; Gándara, F.; Zhang, Y.-B.; Jiang, J.; Queen, W. L.; Hudson, M. R.; Yaghi, O. M. Water Adsorption in Porous Metal-Organic Frameworks and Related Materials. J. Am. Chem. Soc. 2014, 136 (11), 4369-4381. https://doi.org/10.102/ja500330a.

(27) Qi, Q.; Lv, X.; Lv, W.; Yang, Q. H. Multifunctional Binder Designs for Lithium-Sulfur Batteries. J. Energy Chem. 2019, 39, 88-100. https://doi.org/10.1016/j.jechem.2019.02.001.

(28) Sun, K.; Cama, C. A.; Huang, J.; Zhang, Q.; Hwang, S.; Su, D.; Marschilok, A. C.; Takeuchi, K. J.; Takeuchi, E. S.; Gan, H. Effect of Carbon and Binder on High Sulfur Loading Electrode for Li-S Battery Technology. Electrochim. Acta 2017, 235, 399-408. https://doi.org/10.1016/j.electacta.2017.03.023.

(29) Novoselov, K. S.; Fal’Ko, V. I.; Colombo, L.; Gellert, P. R.; Schwab, M. G.; Kim, K. A Roadmap for Graphene. Nature 2012, 490, 192-200. https://doi.org/10.1038/nature11458.

(30) Kholmanov, I. N.; Magnuson, C. W.; Aliev, A. E.; Li, H.; Zhang, B.; Suk, J. W.; Zhang, L. L.; Peng, E.; Mousavi, S. H.; Khanikaev, A. B.; Piner, R.; Shvets, G.; Ruoff, R. S. Improved Electrical Conductivity of Graphene Films Integrated with Metal Nanowires. Nano Lett. 2012, 12 (11), 5679-5683. https://doi.org/10.1021/n1302870x.

(31) Secor, E. B.; Prabhumirashi, P. L.; Puntambekar, K.; Geier, M. L.; Hersam, M. C. Inkjet Printing of High Conductivity, Flexible Graphene Patterns. J. Phys. Chem. Lett. 2013, 4 (8), 1347-1351. htts://doi.org/10.1021/jz400644c.

(32) Paton, K. R.; Varrla, E.; Backes, C.; Smith, R. J.; Khan, U.; O’Neill, A.; Boland, C.; Lotya, M.; Istrate, O. M.; King, P.; Higgins, T.; Barwich, S.; May, P; Puczkarskil, P; Ahmed, I.; Moebius, M.; Pettersson, H.; Long, E.; Coelho, J.; O’Brien, S. E.; McGuire, E. K.; Sanchez, B. M.; Duesberg, G. S.; McEvoy, N.; Pennycook, T. J.; Downing, C.; Crossley, A.; Nicolosil, V.; Coleman, J. N. Scalable Production of Large Quantities of Defect-Free Few-Layer Graphene by Shear Exfoliation in Liquids. Nat. Mater. 2014, 13, 624-630. https://doi.org/10.1038/nmat3944.

(33) Liang, Y. T.; Hersam, M. C. Highly Concentrated Graphene Solutions via Polymer Enhanced Solvent Exfoliation and Iterative Solvent Exchange. J. Am. Chem. Soc. 2010, 132 (50), 17661-17663. https://doi.org/10.1021/ja107661g.

(34) Chen, K. S.; Xu, R.; Luu, N. S.; Secor, E. B.; Hamamoto, K.; Li, Q.; Kim, S.; Sangwan, V. K.; Balla, I.; Guiney, L. M.; Seo, J.-W. T.; Yu, X.; Liu, W.; Wu, J.; Wolverton, C.; Dravid, V. P.; Barnett, S. A.; Lu, J.; Amine, K.; Hersam, M. C. Comprehensive Enhancement of Nanostructured Lithium-Ion Battery Cathode Materials via Conformal Graphene Dispersion. Nano Lett. 2017, 17 (4), 2539-2546. https://doi.org/10.1021/acs.nanolet.7b00274.

(35) Hyun, W. J.; De Moraes, A. C. M.; Lim, J. M.; Downing, J. R.; Park, K. Y.; Tan, M. T. Z.; Hersam, M. C. High-Modulus Hexagonal Boron Nitride Nanoplatelet Gel Electrolytes for Solid-State Rechargeable Lithium-Ion Batteries. ACS Nano 2019, 13 (8), 9664-9672. https://doi.org/10.1021/acsnano.9b04989.

(36) Lin, Z.; Liu, Z.; Fu, W.; Dudney, N. J.; Liang, C. Lithium Polysulfidophosphates: A Family of Lithium-Conducting Sulfur-Rich Compounds for Lithium-Sulfur Batteries. Angew. Chem. Int. Ed. Engl. 2013, 52 (29), 7460-7463. https://doi.org/10.1002/anie.201300680.

(37) Hyun, W. J.; Chaney, L. E.; Downing, J. R.; de Moraes, A. C. M.; Hersam, M. C. Printable Hexagonal Boron Nitride Ionogels. Faraday Discuss. 2020. https://doi/org/10.1039/c9fd00113a.

(38) Palomares, V.; Goñi, A.; De Muro, I. G.; De Meatza, I.; Bengoechea, M.; Cantero, I.; Rojo, T. Conductive Additive Content Balance in Li-Ion Battery Cathodes: Commercial Carbon Blacks vs. in Situ Carbon from LiFePO₄/C Composites. J. Power Sources 2010, 195 (22), 7661-7668. https://doi.org/10.1016/j.jpowsour.2010.05.048.

(39) Baumann, A. E.; Burns, D. A.; Díaz, J. C.; Thoi, V. S. Lithiated Defect Sites in Zr Metal-Organic Framework for Enhanced Sulfur Utilization in Li-S Batteries. ACS Appl. Mater. Interfaces 2019, 11 (2), 2159-2167. https://doi.org/10.1021/acsami.8b19034.

(40) Liu, J.; Zhang, Q.; Sun, Y. K. Recent Progress of Advanced Binders for Li-S Batteries. J. Power Sources 2018, 396, 19-32. https://doi.org/10.1016/j.jpowsour.2018.05.096.

(41) Xu, Z. L.; Kim, S. J.; Chang, D.; Park, K. Y.; Dae, K. S.; Dao, K. P.; Yuk, J. M.; Kang, K. Visualization of Regulated Nucleation and Growth of Lithium Sulfides for High Energy Lithium Sulfur Batteries. Energy Environ. Sci. 2019, 12, 3144-3155. https://doi.org/10.1039/c9ee01338e.

(42) Secor, E. B.; Gao, T. Z.; Islam, A. E.; Rao, R.; Wallace, S. G.; Zhu, J.; Putz, K. W.; Maruyama, B.; Hersam, M. C. Enhanced Conductivity, Adhesion, and Environmental Stability of Printed Graphene Inks with Nitrocellulose. Chem. Mater. 2017, 29 (5), 2332-2340. https://doi.org/10.1021/acs.chemmater.7b00029.

(43) Lin, Z. J.; Zheng, H. Q.; Zeng, Y. N.; Wang, Y. L.; Chen, J.; Cao, G. J.; Gu, J. F.; Chen, B. Effective and Selective Adsorption of Organoarsenic Acids from Water over a Zr-Based Metal-Organic Framework. Chem. Eng. J. 2019, 378, 122196. https://doi.org/10.1016/j.cej.2019.122196.

(44) Zhang, W.; Bu, A.; Ji, Q.; Min, L.; Zhao, S.; Wang, Y.; Chen, J. P Ka-Directed Incorporation of Phosphonates into MOF-808 via Ligand Exchange: Stability and Adsorption Properties for Uranium. ACS Appl. Mater. Interfaces 2019, 11 (37), 33931-33940. https://doi.org/10.1021/acsami.9b10920.

(45) Dapoz, S.; Betz, N.; Guittet, M. J.; Le Moël, A. ESCA Characterization of Heparin-like Fluoropolymers Obtained by Functionalization after Grafting Induced by Swift Heavy Ion Irradiation. Nucl. Inst. Methods Phys. Res. B 1995, 105, 120-125. https://doi.org/10.1016/0168-583X(95)00823-3.

(46) Zhu, Y.; Wang, J.; Zhang, F.; Gao, S.; Wang, A.; Fang, W.; Jin, J. Zwitterionic Nanohydrogel Grafted PVDF Membranes with Comprehensive Antifouling Property and Superior Cycle Stability for Oil-in-Water Emulsion Separation. Adv. Funct. Mater. 2018, 28, 1804121. https://doi.org/10.1002/adfm.201804121.

(47) Wang, G.; Sharp, C.; Plonka, A. M.; Wang, Q.; Frenkel, A. I.; Guo, W.; Hill, C.; Smith, C.; Kollar, J.; Troya, D.; Morris, J. R. Mechanism and Kinetics for Reaction of the Chemical Warfare Agent Simulant, DMMP(g), with Zirconium(IV) MOFs: An Ultrahigh-Vacuum and DFT Study. J. Phys. Chem. C 2017, 121 (21), 11261-11272. https://doi.org/10.1021/acs.jpcc.7b00070.

(48) Wasalathilake, K. C.; Roknuzzaman, M.; Ostrikov, K.; Ayoko, G. A.; Yan,C. Interaction Between Functionalized Graphene and Sulfur Compounds in a Lithium-Sulfur Battery - a Density Functional Theory Investigation. RSC Adv. 2018, 8, 2271-2279. https://doi.org/10.1039/c7ra11628d.

(49) Zhang, T.; Marinescu, M.; Walus, S.; Kovacik, P.; Offer, G. J. What Limits the Rate Capability of Li-S Batteries during Discharge: Charge Transfer or Mass Transfer? J. Electrochem. Soc. 2018, 165 (1), A6001-A6004. https://doi.org/10.1149/2.0011801jes.

(50) Li, L.; Pascal, T. A.; Connell, J. G.; Fan, F. Y.; Meckler, S. M.; Ma, L.; Chiang, Y. M.; Prendergast, D.; Helms, B. A. Molecular Understanding of Polyelectrolyte Binders That Actively Regulate Ion Transport in Sulfur Cathodes. Nat. Commun. 2017, 8, 2277. https://doi.org/10.1038/s41467-017-02410-6.

(51) Shaibani, M.; Mirshekarloo, M. S.; Singh, R.; Easton, C. D.; Dilusha Cooray, M. C.; Eshraghi, N.; Abendroth, T.; Dörfler, S.; Althues, H.; Kaskel, S.; et al. Expansion-Tolerant Architectures for Stable Cycling of Ultrahigh-Loading Sulfur Cathodes in Lithium-Sulfur Batteries. Sci. Adv. 2020, 6, eaay2757. https://doi.org/10.1126/sciadv.aay2757.

(52) Zhang, J.; Shi, Y.; Ding, Y.; Peng, L.; Zhang, W.; Yu, G. A Conductive Molecular Framework Derived Li₂S/N,P-Codoped Carbon Cathode for Advanced Lithium-Sulfur Batteries. Adv. Energy Mater. 2017, 7, 1602876. https://doi.org/10.1002/aenm.201602876.

(53) Al Salem, H.; Babu, G.; V. Rao, C.; Arava, L. M. R. Electrocatalytic Polysulfide Traps for Controlling Redox Shuttle Process of Li-S Batteries. J. Am. Chem. Soc. 2015, 137 (36), 11542-11545. https://doi.org/10.1021/jacs.5b04472.

### SUPPLEMENTAL INFORMATION FOR THE EXAMPLES

### 1. Experimental

### 1.1. MOF Synthesis

MOF-808 was synthesized by modifying previously reported procedures.^{1,2} In our scaled synthesis, 1.26 g of ZrOCl₂·8 H₂O (Alfa Aesar, 3.9 mmol) and 0.51 g of 1,3,5-benzenetricarboxylic acid (H₃BTC, TCI America, 2.4 mmol) were added to a 250 mL flask and dissolved in 55 mL of N,N-dimethylformamide (DMF, Sigma) and 55 mL of formic acid (Alfa Aesar). Once all reagents dissolved, the flask was transferred to a 120° C. oven. After 24 h, the flask was removed from the oven and allowed to cool, a large amount of white solid was observed in the bottom of the flask. The solids were collected by centrifugation and washed 4 × 50 mL over 48 h, followed by 4 × 50 mL of acetone (Sigma) over an additional 48 h. The sample was then dried in a 100° C. oven overnight. The recovered yield of the dried powder was 0.6 g dried from acetone.

LPS-MOF-808 was synthesized following our previous report without modification and stored in an Ar filled glovebox.³ The stoichiometry of Li₃PS₄ to MOF-808 used in the synthesis was 2 to 1 (labelled as 2×LPS-MOF-808 in the previous report). The thiophosphate moiety is sensitive to hydrolysis and was handled exclusively under inert atmosphere.

### 1.2. Sulfur Loading Procedure

Roughly 100 mg of MOF-808 was first activated chemically via 5x sequential wash/soak cycles with 10 mL of acetone and then 5× 10 mL wash/soak cycles of dichloromethane (DCM, Sigma). After the last DCM soaking, the solvent was removed in vacuo at room temperature for 2 h. The chemically activated MOF was then thermally activated by continued evacuation at 180° C. over 2 h and brought into an Ar filled glovebox.

In the glovebox, MOF-808 or LPS-MOF-808 samples were weighed and added to a finely ground in a mortar and pestle. Depending on the desired loading ratio, the mass of sulfur was calculated (S:MOF - 1:1 or 3:2 by mass) and ground with the MOF. The fine MOF-808 + S mixture was collected from the mortar and pestle and added to a 10 mL recovery flask. A small stainless-steel ball was added to further mix the solids later. The flask was sealed with a Schlenk adapter, brought out of the glovebox, and evacuated for 10 min at room temperature. The flask was then vortexed to further homogenize the powder mixture for 5 min, then placed in a 155° C. mantle for 2 h. The 1:1 mass ration of S:MOF loading procedure afforded nearly 190 mg of a cream-colored MOF-808@S sample. The LPS-MOF-808@S sample was returned to the glovebox after sulfur loading for storage and use.

### 1.3. GEC Synthesis

Synthesis of GEC powder utilized a protocol modified from previous reports.^{4,5} First, 6000 g of +100 mesh flake graphite (Millipore Sigma) was combined with 200 g of 4 cP ethyl cellulose (Millipore Sigma) in a reservoir tank containing 5 U.S. gallons of 190-proof ethanol (Decon Labs, Fisher Scientific). This mixture was continuously recirculated through an inline shear mixer (Silverson Machines, Model 200L) for 23 hr. The shear mixing rotor/stator assembly was outfitted with a square hole, high shear screen with a 1.5 HP motor.

After collection from the mixer, the dispersion was centrifuged (Beckman Coulter, Avanti-J26 XPI) in a high-speed instrument using a fixed-angle rotor (Beckman Coulter, Model JLA 8.1000) at 6500 rpm for 0.5 hours. The supernatant containing polydisperse graphene with ethyl cellulose was then collected and flocculated with a saltwater mixture to crash out solid powder. For this flocculation step, the supernatant was combined with 0.04 g mL⁻¹ NaCl in deionized water in a 1.74:1 mass ratio and centrifuged again at 7000 rpm for 7 minutes. The sedimented solids comprised of graphene, ethyl cellulose and salt were retrieved from the bottles and washed with deionized water in a vacuum filtration setup (qualitative filter paper, Fisher Scientific). The washing was implemented until the filtrate registered a salt concentration of 0.00 ppt measured by a traceable salinity meter pen (Fisher Scientific). Finally, the GEC flocculant was fully dehydrated in ambient conditions using a 150-watt infrared lamp. The dry GEC solids were then ground into a fine powder with a porcelain mortar and pestle for characterization before being incorporated into Li-S battery cathode slurries.

### 1.4. Electrochemistry

Electrodes were prepared by casting sulfur-loaded MOF composite slurries onto pre-weighed ½ inch diameter carbon paper disks (Toray carbon paper 120). The cathode slurry was prepared by adding 10 % GEC and 90 % sulfur-loaded MOF (by mass) to small vials along with a small stainless-steel ball unless otherwise noted. All slurry formulations are provided in Table 1. N-methyl-2- pyrrolidone (NMP, Oakwood Chemical) was added to and the sample vortexed until an ideal consistency was achieved (typically 4 - 5x the solid component mass). The mixture was vortexed for 30 min to homogenize the slurry and left overnight. Afterwards, the slurry was vortexed again for 10 min and then immediately spread onto the carbon paper disks. The coated cathodes were placed into an 80° C. oven and dried for a minimum of 8 h. The dried cathodes were removed from the casting support, pressed, and weighed to accurately determine the amount of slurry (and thus sulfur) added to each cathode. The cathodes were transferred to an Ar filled glovebox until further use.

Sulfur-loaded LPS-MOF-808 composite cathodes were constructed in the glovebox in a similar manner. Instead of NMP, dried and deoxygenated 1,2-dimethoxyethane (DME, Sigma) was used to suspend the slurry components. The slurry sample was vortexed and cast as described above all under Ar atmosphere. The cathodes were dried in the glovebox at room temperature.

Cathodes were assembled into size CR2032 coin cells (TOB New Energy) along with two spacers, a spring, two Celgard separators, and a polished Li anode. The electrolyte composed of 1 M bis-(trifluoromethanesulfonyl)imide lithium (LiTFSI, Oakwood Chemical) in a mixed solution of distilled DME and distilled 1,3-dioxolane (DOL, Acros Organics) (1:1 by volume) with 2 % lithium nitrate salt by mass (LiNO₃, Strem Chemicals) was added to each cell using a fixed ratio of 60 µL per mg S. The mass of sulfur on each cathode was determined using the S mass % of the sulfur-loaded MOF sample calculated from TGA experiments, the slurry formulation, and the mass of slurry on each cathode. The cells were assembled entirely in an Ar atmosphere.

Cells were cycled galvanostatically (MNT-BA-5V, MicroNanoTools) after resting for 8 h. All cells were cycled at a C-rate of C/2 (840 mAh g⁻¹ S) unless otherwise stated. To obtain sufficient statistical significance, at least three coin cells were tested under the same conditions for standard experiments. Galvanostatic intermittent titration technique (GITT) experiments were conducted on cells after 5x galvanostatic charge/discharge cycles using a pulse duration of 10 min at a rate of C/10 followed by a rest period of 1 h. The pulse/rest process was repeated until the cell potential reached 1.6 V vs Li/Li⁺.

Electrochemical impedance spectra (EIS) were collected using an Ivium-n-STAT Multichannel Electrochemical Analyzer on cells in the discharged state following 100 galvanostatic charge-discharge cycles. EIS spectra were collected from 1 MHz to 0.1 Hz at the cell’s open circuit potential with an AC current amplitude of 10 mV. The collected spectra were fit using a R1-R2//CPE1-R3//CPE2 equivalent circuit (shown in FIGS. 23A-23F), where R1 corresponds to the electrolyte resistance, R2 represents the resistance from insulating species on both electrodes, and R3 is related to charge transfer resistance.⁶⁻⁸ The capacitive components (CPE1 and CPE2) are constant phase elements that define the height of the semicircle in the Nyquist plot.^{7,9} All fitted models exhibited errors less than 5 %.

Cyclic voltammetry (CV) experiments were also conducted using an Ivium-n-STAT Multichannel Electrochemical Analyzer at various scan rates from 0.1 to 0.5 mV s⁻¹ between 1.6 and 2.9 V vs. Li/Li⁺.

### 1.5. Instrumentation

Thermogravimetric analyses (TGA) of the sulfur-loaded MOF samples were conducted using an SDT Q600 (TA Instruments) under flowing Ar and a heating rate of 5.0° C. min⁻¹. The mass of sulfur in each sulfur-loaded MOF sample is calculated from the mass loss % curve using the first derivate curve to define the sulfur loss event(s). TGA of GEC was conducted in a Mettler Toledo instrument flowing compressed air (50 mL min⁻¹) at a heating rate of 7.5° C. min⁻¹. Powder X-ray diffraction (XRD) patterns were collected using a Bruker D8 Focus diffractometer employing Cu Kα radiation and a LynxEye detector. Infrared spectra (FT-IR) were collected using a ThermoScientific Nicolet iS FT-IR with iD 5 ATR attachment.

Scanning electron micrographs of electrode samples were collected using a JEOL JSM IT100 Scanning Electron Microscope. Electrodes were mounted vertically for observation with an accelerating voltage of 20 kV and a 10 mm working distance. Scanning electron microscopy and electron dispersive spectroscopy on MOF powders and slurries were both conducted using a Hitachi SU8030 scanning electron microscope. For qualitative energy dispersive X-ray spectroscopy (EDS) of slurry samples, powder was deposited onto standard Al pin stubs (Hitachi) and plasma-coated with 7 nm osmium. An accelerating voltage of 30 kV was used with a 15 mm working distance and a 100 micro-second dwell time per pixel. For qualitative EDS of single MOF-808 crystals, 1 mg/mL powder was dissolved into isopropyl alcohol and drop-casted onto 300 mesh lacey carbon TEM grids (Ted Pella); all EDS mapping was conducted using AZtec NanoAnalysis software (Oxford Instruments).

Raman spectroscopy was conducted using a Raman laser microscope (Horiba LabRAM HR Evolution) equipped with a 532 nm excitation wavelength laser; an acquisition time of 30 s and 2400 g mm⁻¹ grating was used.

X-ray photoelectron spectroscopy was conducted using a Thermo Scientific ESCALAB 250Xi, employing a monochromatic KR-Al X-ray source and flood gun. Peak fitting was conducted using Avantage Processing software (Thermo Scientific), and all spectra were subsequently charge-corrected to a 284.80 eV C1s peak.

Atomic force microscopy of GEC samples drop-casted onto 300 nm SiO₂/Si was conducted using a Cypher AFM (Asylum Research) in standard tapping mode. Flake size distributions were obtained using a customized MATLAB image processing algorithm that employed a canny edge boundary approximation for determining flake thresholds.

$${i}_{p} = \left(0.4463\right) n F A C {\left(\frac{n F v D}{R T}\right)}^{1 / 2}$$

The Randles-Sevcik equation relates the peak current (iₚ) to diffusion coefficient (D) as a function of the scan rate (v) using several parameters. Here, n is the number of electrons transferred in the redox event, F is the Faraday constant, A is the electrode surface area, C is the concentration, R is the ideal gas constant, and T is the temperature.

In CV, the current is limited by diffusion of redox species to the electrode surface. Diffusion itself is driven by a concentration gradient near the electrode generated by the applied potential, as set by the Nernst equation. However, the electrode surface area is not the same for these different cathode formulations, evidenced by our SEM images, nor is the ratio of i_{pc1} to i_{pc2} the same for each system. Both of these factors prohibit us from directly comparing the slopes as accurate method to compare diffusion here. We have included the results to highlight there are electrochemical differences in these systems under potential controlled regimes.

Regardless of these differences among electrode morphology, it is worth noting the MOF-808+S/SP-75 consistently exhibits a large slope, thus suggesting fast diffusion, compared to the other MOF-808@S containing samples.

Equations for GITT Analysis:

$$D = \left(\frac{4}{π}\right) {\left(\frac{{V}_{e l e c}}{τ \text{} A}\right)}^{2} {\left(\frac{Δ {E}_{r e l a x}}{d Δ {E}_{p u l s e} / d \sqrt{t}}\right)}^{2}$$

The derivation of the equation above used to calculate the diffusion coefficient (D) from GITT profiles is provided in a previous report.¹⁰ The electrolyte volume used in the cell (V_{elec}) is determined by the mass of sulfur on the cathode. The pulse duration (τ) and the cathode area (A) is the same for every cell. The potential relaxation after the current pulse (ΔEᵣₑₗₐₓ) and the slope of the potential vs. square root time graph (dΔEₚᵤₗₛₑ/d√t) terms are obtained from the GITT experiment.

In galvanostatic experiments, current rather than potential is applied to influence the electrochemistry of the cell. During the current interrupt period, any concentration gradient near the electrode surface dissipates to homogenize with the bulk solution. At the initiation of the current pulse, the transfer of electrons to redox active substrates re-establishes a potential and concentration gradient at the electrode surface. This process continues until the steady state equilibrium potential is again reached. The rate of this process is given by the (dΔEₚᵤₗₛₑ/d√t) term.

As discussed above, the electrochemically accessible surface area of these electrodes may not be uniform, so these values should be used qualitatively.

### 3. References for Supplemental Information

(1) Furukawa, H.; Gándara, F.; Zhang, Y.-B.; Jiang, J.; Queen, W. L.; Hudson, M. R.; Yaghi, O. M. Water Adsorption in Porous Metal-Organic Frameworks and Related Materials. J. Am. Chem. Soc. 2014, 136 (11), 4369-4381. https://doi.org/10.1021/ja500330a.

(2) Mautschke, H.-H.; Drache, F.; Senkovska, I.; Kaskel, S.; Llabrés i Xamena, F. X. Catalytic Properties of Pristine and Defect-Engineered Zr-MOF-808 Metal Organic Frameworks. Catal. Sci. Technol. 2018, 8 (14), 3610-3616. https://doi.org/10.1039/C8CY00742J.

(3) Baumann, A. E.; Han, X.; Butala, M. M.; Thoi, V. S. Lithium Thiophosphate Functionalized Zirconium MOFs for Li-S Batteries with Enhanced Rate Capabilities. J. Am. Chem. Soc. 2019, 141 (44), 17891-17899. https://doi.org/10.1021/jacs.9b09538.

(4) Secor, E. B.; Prabhumirashi, P. L.; Puntambekar, K.; Geier, M. L.; Hersam, M. C. Inkjet Printing of High Conductivity, Flexible Graphene Patterns. J. Phys. Chem. Lett. 2013, 4 (8), 1347-1351. https://doi.org/10.1021/jz400644c.

(5) Secor, E. B.; Ahn, B. Y.; Gao, T. Z.; Lewis, J. A.; Hersam, M. C. Rapid and Versatile Photonic Annealing of Graphene Inks for Flexible Printed Electronics. Adv. Mater. 2015, 27 (42), 6683-6688. https://doi.org/10.1002/adma.201502866.

(6) Deng, Z.; Zhang, Z.; Lai, Y.; Liu, J.; Li, J.; Liu, Y. Electrochemical Impedance Spectroscopy Study of a Lithium/Sulfur Battery: Modeling and Analysis of Capacity Fading. J. Electrochem. Soc. 2013, 160 (4), A553-A558. https://doi.org/10.1149/2.026304jes.

(7) Kolosnitsyn, V. S.; Kuzmina, E. V.; Karaseva, E. V.; Mochalov, S. E. A Study of the Electrochemical Processes in Lithium-Sulphur Cells by Impedance Spectroscopy. J. Power Sources 2011, 196 (3), 1478-1482. https://doi.org/10.1016/j.jpowsour.2010.08.105.

(8) Lang, S. Y.; Shi, Y.; Guo, Y. G.; Wang, D.; Wen, R.; Wan, L. J. Insight into the Interfacial Process and Mechanism in Lithium-Sulfur Batteries: An In Situ AFM Study. Angew. Chemie - Int. Ed. 2016, 55 (51), 15835-15839. https://doi.org/10.1002/anie.201608730.

(9) Peled, E.; Goor, M.; Schektman, I.; Mukra, T.; Shoval, Y.; Golodnitsky, D. The Effect of Binders on the Performance and Degradation of the Lithium/Sulfur Battery Assembled in the Discharged State. J. Electrochem. Soc. 2017, 164 (1), A5001-A5007. https://doi.org/10.1149/2.0161701jes.

(10) Dibden, J. W.; Meddings, N.; Owen, J. R.; Garcia-Araez, N. Quantitative Galvanostatic Intermittent Titration Technique for the Analysis of a Model System with Applications in Lithium-Sulfur Batteries. ChemElectroChem 2018, 5 (3), 445-454. https://doi.org/10.1002/celc.201701004.

While various embodiments of the present invention have been described above, they have been presented by way of example only, and not limitation. Thus, the breadth and scope of the present invention should not be limited by any of the above-described illustrative embodiments but should instead be defined only in accordance with the following claims and their equivalents.

The embodiments illustrated and discussed in this specification are intended only to teach those skilled in the art how to make and use the invention. In describing embodiments of the disclosure, specific terminology is employed for the sake of clarity. However, the disclosure is not intended to be limited to the specific terminology so selected. The above-described embodiments of the disclosure may be modified or varied, without departing from the invention, as appreciated by those skilled in the art considering the above insights. It is therefore to be understood that, within the scope of the claims and their equivalents, the invention may be practiced otherwise than as specifically described. For example, it is to be understood that the present disclosure contemplates that, to the extent possible, one or more features of any embodiment can be combined with one or more features of any other embodiment.

We claim:

1. A composition for producing electrodes for lithium-sulfur batteries, comprising:
particles having a metal-organic framework structure and composition that define voids within said metal-organic framework structure;
sulfur loaded into at least some of said voids defined by said metal-organic framework structure of said particles;
graphene flakes obtained by polymer enhanced solvent exfoliation; and
polymer residue from said polymer enhanced solvent exfoliation,
wherein said particles and said flakes are small relative to said electrodes to form a composite electrode bound at least partially by said polymer residue.

2. The composition of claim 1, wherein said polymer residue is ethyl cellulose.

3. The composition of claim 1, wherein said polymer residue comprises at least one of a cellulosic ether, celluloid, cellulose derivative, cellulosic ester, polyphenol, acrylate, or methacrylate.

4. The composition of claim 3, wherein said polymer residue comprises at least one of hydroxypropyl methylcellulose (HPMC), hydroxypropyl cellulose (HPC), hydroxyethyl cellulose (HEC), methyl cellulose (MC), carboxymethylcellulose (CMC), cellulose nitrate/nitrocellulose (NC), cellulose nanofibers (CNFs), cellulose nanocrystals (CNCs), cellulose acetate (CAc), cellulose acetate-propionate (CAP), cellulose acetate-butyrate (CAB), a tannin, tannic acid, poly(methyl methacrylate) (PMMA), polyethylene glycol methacrylate (PEGMA), methacrylic acid (MAA), allyl methacrylate (AllMA), butyl acrylate (BA), (dimethylamino) ethyl methacrylate (DMAEMA), sodium taurodeoxycholate, sodium cholate (SC), sodium dodecyl sulfate (SDS), sodium lignosulfonate, calcium lignosulfonate, polyvinyl alcohol (PVA), poly(vinylidene fluoride) (PVDF), poly(acrylic acid) (PAA), or polyvinylpyrrolidone (PVP).

5. The composition of claim 2, wherein said graphene flakes and said ethyl cellulose are in a weight ratio ranging from 15:85 to 60:40.

6. The composition of claim 5, wherein said graphene flakes and said ethyl cellulose are in a weight ratio of about 1:1.

7. The composition of claim 1, wherein said metal-organic framework structure is MOF-808.

8. The composition of claim 1, wherein said metal-organic framework structure is a zirconium-based MOF.

9. The composition of claim 1, wherein said metal-organic framework structure is one of MOF-808, UiO-66, or NU-1000.

10. The composition of claim 1, wherein said graphene flakes have a lateral dimension within the range of 50 nm to 1,000 nm.

11. The composition of claim 1, wherein said graphene flakes have a lateral dimension within the range of 100 nm to 650 nm.

12. The composition of claim 1, wherein said graphene flakes have a lateral dimension within the range of 100 nm to 200 nm.

13. A method of producing a composite electrode for a lithium-sulfur battery comprising:
obtaining a composition according to claim 1; and
applying said composition to a substrate.

14. The method of producing a composite electrode for a lithium-sulfur battery according to claim 13, further comprising producing said composition.

15. An electrode for a lithium-sulfur battery comprising a layer having the composition according to claim 1.

16. A lithium-sulfur battery comprising an electrode according to claim 15.
